(19) United States
(12) Patent Application Publication
(10) Pub. No.: US 2011/0262728 A1
(43) Pub. Date: Oct. 27, 2011

(54) THERMAL CONDUCTIVE SHEET, LIGHT-EMITTING DIODE MOUNTING SUBSTRATE, AND THERMAL CONDUCTIVE ADHESIVE SHEET

(75) Inventors: Seiji IZUTANI, Osaka (JP); Hisae UCHIYAMA, Osaka (JP); Takahiro FUKUOKA, Osaka (JP); Kazutaka HARA, Osaka (JP); Hitotsugu HIRANO, Osaka (JP)

(73) Assignee: NITTO DENKO CORPORATION, Osaka (JP)

(21) Appl. No.: 13/016,685

(22) Filed: Jan. 28, 2011

(30) Foreign Application Priority Data
Jan. 29, 2010 (JP) 2010-018256
Apr. 9, 2010 (JP) 2010-090908
Jul. 16, 2010 (JP) 2010-161845
Jul. 16, 2010 (JP) 2010-161846
Jul. 16, 2010 (JP) 2010-161848
Jul. 16, 2010 (JP) 2010-161851

(51) Int. Cl. B32B 3/00; B32B 5/16

(52) U.S. Cl. 428/220; 428/323

(57) ABSTRACT

A thermal conductive sheet contains a plate-like boron nitride particle, has a thermal conductivity in a direction perpendicular to the thickness direction of the thermal conductive sheet of 4 W/m·K or more, and has a volume resistivity of 1×10¹⁰ Ω·cm or more. The transmittance of light at a wavelength of 500 nm is 10% or less. The surface reflectance R of light at 500 nm is 70% or more relative to the surface reflectance of barium sulfate as 100%. A light-emitting diode mounting substrate includes a substrate for mounting a light-emitting diode; and a thermal conductive light reflection layer being formed on the surface of the substrate and including the above-described thermal conductive sheet. A thermal conductive adhesive sheet includes a thermal conductive layer including the above-described thermal conductive sheet, and an adhesive layer or a pressure-sensitive adhesive layer laminated on at least one side of the thermal conductive layer.

### CROSS-REFERENCE TO RELATED APPLICATION

The present application claims priority from Japanese Patent Applications No. 2010-018256 filed on Jan. 29, 2010; No. 2010-090908 filed on Apr. 9, 2010; No. 2010-161845 filed on Jul. 16, 2010; No. 2010-161848 filed on Jul. 16, 2010; No. 2010-161851 filed on Jul. 16, 2010; and No. 2010-161846 filed on Jul. 16, 2010, the contents of which are hereby incorporated by reference into this application.

### BACKGROUND OF THE INVENTION

1. Field of the Invention

The present invention relates to a thermal conductive sheet, to be specific, to a thermal conductive sheet suitably used for dissipating heat of electrondevices.

The present invention further relates to, to be specific, a thermal conductive sheet for use in power electronics technology.

The present invention further relates to a light-emitting diode mounting substrate.

2. Description of Related Art

A mounting substrate including electron devices such as IC chips, condensers, and resistors mounted on a substrate is hitherto known. In particular, for example, a flexible printed circuit including a base material, a conductor layer formed into a predetermined pattern thereon, and an insulative protection layer covering them has been proposed (e.g., see Japanese Unexamined Patent Publication No. 2002-57442). The insulative protection layer described in Japanese Unexamined Patent Publication No. 2002-57442 is formed from a resin such as polyurethane resin, polyester resin, or polyamide resin.

Furthermore, in recent years, power electronics technology which uses semiconductor elements to convert and control electric power is applied in hybrid devices, high-brightness LED devices, and electromagnetic induction heating devices. In power electronics technology, a high current is converted to, for example, heat, and therefore materials that are disposed near the semiconductor element are required to have excellent heat dissipation characteristics (excellent heat conductivity).

For example, covering a CPU with a silicone resin has been proposed (e.g., see Japanese Unexamined Patent Publication No. 2010-10469).

A light-emitting diode mounting substrate is a substrate formed with wirings, and after the light-emitting diode mounting substrate is produced, an LED (light-emitting diode) is mounted on the substrate so as to be connected to the wirings.

In such an LED mounting substrate, for example, an improvement in luminous efficacy of the LED mounting substrate by using a light reflective alumina substrate to reflect light emitted from LED has been proposed (e.g., see Japanese Unexamined Patent Publication No. 2010-10469).

Also, for example, a thermal conductive sheet containinia plate-like boron nitride powder and an acrylic ester copolymer resin has been proposed (e.g., see Japanese Unexamined Patent Publication No. 2008-280496).

In the thermal conductive sheet of Japanese Unexamined Patent Publication No. 2008-280496, the boron nitride powder is oriented so as to orient its major axis direction (direction perpendicular to the plate thickness of the boron nitride powder) in the thickness direction of the sheet, and thermal conductivity in the thickness direction of the thermal conductive sheet is improved in this way.

### SUMMARY OF THE INVENTION

However, in the mounting substrate including a flexible printed circuit of Japanese Unexamined Patent Publication No. 2002-57442, electron devices to be mounted generate heat, and therefore the heat from the electron devices needs to be efficiently conducted. However, the insulative protection layer of Japanese Unexamined Patent Publication No. 2002-57442 is disadvantageous in that the heat cannot be conducted sufficiently.

Furthermore, however, the silicone resin of Japanese Unexamined Patent Publication No. 2010-10469 is disadvantageous in that the heat generated from the CPU cannot be conducted efficiently.

Furthermore, when various marks are formed on the surface of the silicone resin, and the surface is observed, because the silicone resin of Japanese Unexamined Patent Publication No. 2010-10469 has excellent transparency, not only the marks but also the internal structure of the CPU is viewed, and this causes problems: the images are overlapped and the marks cannot be identified clearly.

Furthermore, because LEDs undergo high temperature, the heat needs to be conducted to outside so that deterioration of luminous efficacy of the LED is prevented. However, the alumina substrate described in Japanese Unexamined Patent Publication No. 2008-280496 performs isotropic heat conduction, i.e., the heat conduction is proportional in the plane direction and in the thickness direction, and therefore it is disadvantageous in that the heat from the LED cannot be conducted sufficiently and efficiently.

Furthermore, however, there is a case where high thermal conductivity is required in a direction (plane direction) perpendicular to the thickness direction in the thermal conductive sheet depending on its uses and purposes. In such a case, because the major axis direction of the boron nitride powder is perpendicular to (crosses) the plane direction in the thermal conductive sheet of Japanese Unexamined Patent Publication No. 2008-280496, there is disadvantage in that the thermal conductivity in the plane direction is insufficient.

Furthermore, there are cases where excellent adhesiveness or pressure-sensitive adhesiveness to a heat-dissipation object is required in the thermal conductive sheet depending on its use, but the thermal conductive sheet of Japanese Unexamined Patent Publication No. 2008-280496 is disadvantageous in that adhesiveness or pressure-sensitive adhesiveness to the heat-dissipation object is insufficient.

An object of the present invention is to provide a thermal conductive sheet that is excellent in thermal conductivity in the plane direction, and also excellent in electrical insulation.

Another object of the present invention is to provide a thermal conductive sheet excellent in thermal conductivity in the plane direction, and also excellent in hiding characteristics.

Another object of the present invention is to provide a thermal conductive sheet that is excellent in thermal conductivity in the plane direction and also excellent in surface reflectance; and a light-emitting diode mounting substrate including a thermal conductive light reflection layer including the thermal conductive sheet.

Another object of the present invention is to provide a thermal conductive adhesive sheet that is excellent in thermal conductivity in the plane direction, and also excellent in adhesiveness or pressure-sensitive adhesiveness.

A thermal conductive sheet of the present invention includes a plate-like boron nitride particle, wherein the thermal conductivity in a direction perpendicular to the thickness direction of the thermal conductive sheet is 4 W/m·K or more, and the volume resistivity is 1×10¹⁰∩·cm or more.

Thermal conductive sheet of the present invention is excellent in thermal conductivity in a plane direction perpendicular to the thickness direction, and also excellent in electrical insulation.

Therefore, by covering the electron devices with the thermal conductive sheet of the present invention, the electron devices can be protected and heat from the electron devices can be conducted efficiently at the same time, and also a short circuit between the electron devices can be prevented.

A thermal conductive sheet of the present invention includes a plate-like boron nitride particle, wherein the thermal conductivity in a direction perpendicular to the thickness direction of the thermal conductive sheet is 4 W/m·K or more, and the thermal conductive sheet having a thickness of 300 μm has a transmittance of light at a wavelength of 500 nm of 10% or less.

The thermal conductive sheet of the present invention is excellent in thermal conductivity in a plane direction perpendicular to the thickness direction, and also excellent in hiding characteristics.

Therefore, by covering the electronic components used in power electronics with the thermal conductive sheet of the present invention, and forming a mark on the surface of the thermal conductive sheet, the electronic components are hidden by the thermal conductive sheet when the thermal conductive sheet is observed from the surface thereof. Thus, only the mark can be visually identified without visually identifying the electronic components.

As a result, the mark can be identified clearly, and also heat of the electronic components can be dissipated along the plane direction of the thermal conductive sheet.

A thermal conductive sheet of the present invention includes a plate-like boron nitride particle, wherein the thermal conductivity in a direction perpendicular to the thickness direction of the thermal conductive sheet is 4 W/m·K or more, and the surface reflectance of light at 500 nm is 70% or more relative to the surface reflectance of light at 500 nm of barium sulfate as 100%.

A light-emitting diode mounting substrate of the present invention includes a substrate for mounting a light-emitting diode; and a thermal conductive light reflection layer, the thermal conductive light reflection layer being formed on the surface of the substrate, and including the above-described thermal conductive sheet.

The thermal conductive sheet of the present invention is excellent in thermal conductivity in a plane direction perpendicular to the thickness direction, and also excellent in surface reflectance.

Therefore, by mounting a light-emitting diode on the light-emitting diode mounting substrate including the thermal conductive light reflection layer composed of the thermal conductive sheet of the present invention, light having a specific wavelength emitted from the light-emitting diode can be efficiently reflected at the thermal conductive light reflection layer, and also heat generated from the light-emitting diode can be conducted efficiently by the thermal conductive light reflection layer.

As a result, decrease in luminous efficacy can be reliably prevented.

### BRIEF DESCRIPTION OF THE DRAWINGS

FIG. 1 shows a perspective view of an embodiment of a thermal conductive sheet of the present invention.

FIG. 2 shows process drawings for describing a method for producing the thermal conductive sheet shown in FIG. 1:

(a) illustrating a step of hot pressing a mixture or a laminated sheet,

(b) illustrating a step of dividing the pressed sheet into a plurality of pieces, and

(c) illustrating a step of laminating the divided sheets.

FIG. 3 shows a step of covering electronic components with the thermal conductive sheet shown in FIG. 1, and forming a mark on the thermal conductive sheet.

FIG. 4 shows a cross sectional view of a light-emitting diode mounting substrate including a thermal conductive light reflection layer composed of the thermal conductive sheet shown in FIG. 1.

FIG. 5 shows process drawings for describing a method for producing a light-emitting diode mounting substrate, and a method for mounting a light-emitting diode:

(a) illustrating a step of preparing a substrate,

(b) illustrating a step of forming a thermal conductive light reflection layer,

(c) illustrating a step of forming wirings and producing a light-emitting diode mounting substrate, and

(d) illustrating a step of mounting a light-emitting diode on the light-emitting diode mounting substrate.

FIG. 6 shows a cross sectional view of an embodiment of the thermal conductive adhesive sheet of the present invention.

FIG. 7 shows process drawings for describing a method for allowing the thermal conductive adhesive sheet shown in FIG. 6 to adhere to electronic components and a mounting substrate:

(a) illustrating a step of preparing a thermal conductive adhesive sheet and a mounting substrate, and

(b) illustrating a step of thermocompression bonding the thermal conductive adhesive sheet to the electronic components and the mounting substrate, and then allowing the thermal conductive adhesive sheet to adhere to the electronic components and the mounting substrate by heating.

FIG. 8 shows a cross sectional view of another embodiment (embodiment in which the adhesive/pressure-sensitive adhesive layer is formed with an opening) of the thennal conductive adhesive sheet of the present invention.

FIG. 9 shows process drawings for describing a method for allowing the thermal conductive adhesive sheet shown in FIG. 8 to adhere to electronic components and a mounting substrate:

(a) illustrating a step of preparing the thermal conductive adhesive sheet and the mounting substrate, and

(b) illustrating a step of thermocompression bonding the thermal conductive adhesive sheet to the electronic components and the mounting substrate, and then allowing the thermal conductive adhesive sheet to adhere to or pressure-sensitively adhere to the electronic components and the mounting substrate by heating.

FIG. 10 shows a perspective view of a test device (Type I, before bend test) of a bend test.

FIG. 11 shows a perspective view of a test device (Type I, during bend test) of a bend test.

### DETAILED DESCRIPTION OF THE INVENTION

A thermal conductive sheet of the present invention contains boron nitride particles.

To be specific, the thermal conductive sheet contains boron nitride (BN) particles as an essential component, and further contains, for example, a resin component.

The boron nitride particles are formed into a plate-like (or flake-like) shape, and are dispersed so as to be orientated in a predetermined direction (described later) in the thermal conductive sheet.

The boron nitride particles have an average length in the longitudinal direction (maximum length in the direction perpendicular to the plate thickness direction) of, for example, 1 to 100 μm, or preferably 3 to 90 μm. The boron nitride particles have an average length in the longitudinal direction of, 5 μm or more, preferably 10 μm or more, more preferably 20 μm or more, even more preferably 30 μm or more, or most preferably 40 μm or more, and usually has an average length in the longitudinal direction of, for example, 100 μm or less, or preferably 90 μm or less.

The average thickness (the length in the thickness direction of the plate, that is, the length in the short-side direction of the particles) of the boron nitride particles is, for example, 0.01 to 20 μm, or preferably 0.1 to 15 μm.

The aspect ratio (length in the longitudinal direction/thickness) of the boron nitride particles is, for example, 2 to 10000, or preferably 10 to 5000.

The average particle size of the boron nitride particles as measured by a light scattering method is, for example, 5 μm or more, preferably 10 μm or more, more preferably 20 μm or more, particularly preferably 30 μm or more, or most preferably 40 μm or more, and usually is 100 μm or less.

The average particle size as measured by the light scattering method is a volume average particle size measured with a dynamic light scattering type particle size distribution analyzer.

When the average particle size of the boron nitride particles as measured by the light scattering method is below the above-described range, the thermal conductive sheet may become fragile, and handleability may be reduced.

The bulk density (JIS K 5101, apparent density) of the boron nitride particles is, for example, 0.3 to 1.5 g/cm³, or preferably 0.5 to 1.0 g/cm³.

As the boron nitride particles, a commercially available product or processed goods thereof can be used. Examples of commercially available products of the boron nitride particles include the “PT” series (for example, “PT-110”) manufactured by Momentive Performance Materials Inc., and the “SHOBN®UHP” series (for example, “SHOBN®UHP-1”) manufactured by Showa Denko K.K.

The resin component is a component that is capable of dispersing the boron nitride particles, i.e., a dispersion medium (matrix) in which the boron nitride particles are dispersed, including, for example, resin components such as a thermosetting resin component and a thermoplastic resin component.

Examples of the thermosetting resin component include epoxy resin, thermosetting polyimide, phenol resin, urea resin, melamine resin, unsaturated polyester resin, diallyl phthalate resin, silicone resin, and thermosetting urethane resin.

Examples of the thermoplastic resin component include polyolefin (for example, polyethylene, polypropylene, and ethylene-propylene copolymer), acrylic resin (for example, polymethyl methacrylate), polyvinyl acetate, ethylene-vinyl acetate copolymer, polyvinyl chloride, polystyrene, polyacrylonitrile, polyamide, polycarbonate, polyacetal, polyethylene terephthalate, polyphenylene oxide, polyphenylene sulfide, polysulfone, polyether sulfone, poly ether ether ketone, polyallylsulfone, thermoplastic polyimide, thermoplastic urethane resin, polyamino-bismaleimide, polyamide-imide, polyether-imide, bismaleimide-triazine resin, polymethylpentene, fluorine resin, liquid crystal polymer, olefin-vinyl alcohol copolymer, ionomer, polyarylate, acrylonitrile-ethylene-styrene copolymer, acrylonitrile-butadiene-styrene copolymer, and acrylonitrile-styrene copolymer.

These resin components can be used alone or in combination of two or more.

Of the thermosetting resin components, preferably, the epoxy resin is used.

The epoxy resin is in a state of liquid, semi-solid, or solid under normal temperature.

To be specific, examples of the epoxy resin include aromatic epoxy resins such as bisphenol epoxy resin (e.g., bisphenol A epoxy resin, bisphenol F epoxy resin, bisphenol S epoxy resin, hydrogenated bisphenol A epoxy resin, dimer acid-modified bisphenol epoxy resin, and the like), novolak epoxy resin (e.g., phenol novolak epoxy resin, cresol novolak epoxy resin, biphenyl epoxy resin, and the like), naphthalene epoxy resin, fluorene epoxy resin (e.g., bisaryl fluorene epoxy resin and the like), and triphenylmethane epoxy resin (e.g., trishydroxyphenylmethane epoxy resin and the like); nitrogen-containing-cyclic epoxy resins such as triepoxypropyl isocyanurate (triglycidyl isocyanurate) and hydantoin epoxy resin; aliphatic epoxy resin; alicyclic epoxy resin (e.g., dicyclo ring-type epoxy resin and the like); glycidylether epoxy resin; and glycidylamine epoxy resin.

These epoxy resins can be used alone or in combination of two or more.

Preferably, a combination of a liquid epoxy resin and a solid epoxy resin is used, or more preferably, a combination of a liquid aromatic epoxy resin and a solid aromatic epoxy resin is used. To be more specific, a combination of a liquid bisphenol epoxy resin and a solid triphenylmethane epoxy resin is used, or a combination of a liquid bisphenol epoxy resin and a solid bisphenol epoxy resin is used.

Preferably, a semi-solid epoxy resin is used alone, or more preferably, a semi-solid aromatic epoxy resin is used alone. Examples of those epoxy resins include, in particular, a semi-solid fluorene epoxy resin.

A combination of a liquid epoxy resin and a solid epoxy resin, or a semi-solid epoxy resin can improve conformability to irregularities (described later) of the thermal conductive sheet.

The epoxy resin has an epoxy equivalent of, for example, 100 to 1000 g/eqiv., or preferably 180 to 700 g/eqiv., and has a softening temperature (ring and ball test) of, for example, 80° C. or less (to be specific, 20 to 80° C.), or preferably 70° C. or less (to be specific, 25 to 70° C.).

The epoxy resin has a melt viscosity at 80° C. of for example, 10 to 20,000 mPa·s, or preferably 50 to 15,000 mPa·s. When two or more epoxy resins are used in combination, the melt viscosity of the mixture of these epoxy resins is set within the above-described range.

Furthermore, when an epoxy resin that is solid under normal temperature and an epoxy resin that is liquid under normal temperature are used in combination, a first epoxy resin having a softening temperature of, for example, below 45° C., or preferably 35° C. or less, and a second epoxy resin having a softening temperature of, for example, 45° C. or more, or preferably 55° C. or more are used in combination. In this way, the kinetic viscosity (in conformity with JIS K 7233, described later) of the resin component (mixture) can be set to a desired range, and also, conformability to irregularities of the thermal conductive sheet can be improved.

The epoxy resin can also be prepared as an epoxy resin composition containing, for example, an epoxy resin, a curing agent, and a curing accelerator.

The curing agent is a latent curing agent (epoxy resin curing agent) that can cure the epoxy resin by heating, and examples thereof include an imidazole compound, an amine compound, an acid anhydride compound, an amide compound, a hydrazide compound, and an imidazoline compound. In addition to the above-described compounds, a phenol compound, a urea compound, and a polysulfide compound can also be used.

Examples of the imidazole compound include 2-phenyl imidazole, 2-methyl imidazole, 2-ethyl-4-methyl imidazole, and 2-phenyl-4-methyl-5-hydroxymethyl imidazole.

Examples of the amine compound include aliphatic polyamines such as ethylene diamine, propylene diamine, diethylene triamine, and triethylene tetramine; and aromatic polyamines such as metha phenylenediamine, diaminodiphenyl methane, and diaminodiphenyl sulfone.

Examples of the acid anhydride compound include phthalic anhydride, maleic anhydride, tetrahydrophthalic anhydride, hexahydrophthalic anhydride, 4-methyl-hexahydrophthalic anhydride, methyl nadic anhydride, pyromelletic anhydride, dodecenylsuccinic anhydride, dichloro succinic anhydride, benzophenone tetracarboxylic anhydride, and chlorendic anhydride.

Examples of the amide compound include dicyandiamide and polyamide.

An example of the hydrazide compound includes adipic acid dihydrazide.

Examples of the imidazoline compound include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methylimidazoline.

These curing agents can be used alone or in combination of two or more.

A preferable example of the curing agent is an imidazole compound.

Examples of the curing accelerator include tertiary amine compounds such as triethylenediamine and tri-2,4,6-dimethylaminomethylphenol; phosphorus compounds such as triphenylphosphine, tetraphenylphosphoniumtetraphenylborate, and tetra-n-butylphosphoniurn-o,o-diethylphosphorodithioate; a quaternary ammonium salt compound; an organic metal salt compound; and derivatives thereof. These curing accelerators can be used alone or in combination of two or more.

In the epoxy resin composition, the mixing ratio of the curing agent is, for example, 0.5 to 50 parts by mass, or preferably 1 to 10 parts by mass per 100 parts by mass of the epoxy resin, and the mixing ratio of the curing accelerator is, for example, 0.1 to 10 parts by mass, or preferably 0.2 to 5 parts by mass per 100 parts by mass of the epoxy resin.

The above-described curing agent, and/or the curing accelerator can be prepared and used, as necessary, as a solution, i.e., the curing agent and/or the curing accelerator dissolved in a solvent; and/or as a dispersion liquid, i.e., the curing agent and/or the curing accelerator dispersed in a solvent.

Examples of the solvent include organic solvents including ketones such as acetone and methyl ethyl ketone, ester such as ethyl acetate, and amide such as N,N-dimethylformamide. Examples of the solvent also include aqueous solvents including water, and alcohols such as methanol, ethanol, propanol, and isopropanol. A preferable example is an organic solvent, and more preferable examples are ketones and amides.

Of the thermoplastic resin component, preferably, polyolefin is used.

Preferable examples of polyolefin are polyethylene and ethylene-propylene copolymer.

Examples of polyethylene include a low density polyethylene and a high density polyethylene.

Examples of ethylene-propylene copolymer include a random copolymer, a block copolymer, or a graft copolymer of ethylene and propylene.

These polyolefins can be used alone or in combination of two or more.

The polyolefins have a weight average molecular weight and/or a number average molecular weight of, for example, 1000 to 10000.

The polyolefin can be used alone, or can be used in combination of two or more.

The resin component has a kinetic viscosity as measured in conformity with the kinetic viscosity test of JIS K 7233 (bubble viscometer method) (temperature: 25° C.±0.5° C., solvent: butyl carbitol, resin component (solid content) concentration: 40 mass %) of, for example, 0.22×10⁻⁴ to 2.00×10⁻⁴ m²/s, preferably 0.3×10⁻⁴ to 1.9×10⁻⁴ m²/s, or more preferably 0.4×10⁻⁴ to 1.8×10⁻⁴ m²/s. The above-described kinetic viscosity can also be set to, for example, 0.22×10⁻⁴ to 1.00×10⁻⁴ m²/s, preferably 0.3×10⁻⁴ to 0.9×10⁻⁴ m²/s, or more preferably 0.4×10⁻⁴ to 0.8×10⁻⁴ m²/s.

When the kinetic viscosity of the resin component exceeds the above-described range, excellent flexibility and conformability to irregularities (described later) may not be given to the thermal conductive sheet. On the other hand, when the kinetic viscosity of the resin component is below the above-described range, boron nitride particles may not be oriented in a predetermined direction.

In the kinetic viscosity test in conformity with JIS K 7233 (bubble viscometer method), the kinetic viscosity of the resin component is measured by comparing the bubble rising speed of a resin component sample with the bubble rising speed of criterion samples (having a known kinetic viscosity), and determining the kinetic viscosity of the criterion sample having a matching rising speed to be the kinetic viscosity of the resin component.

In the thermal conductive sheet, the proportion of the volume-based boron nitride particle content (solid content, that is, the volume percentage of boron nitride particles relative to a total volume of the resin component and the boron nitride particles) is, for example, 35 vol % or more, preferably 60 vol % or more, or more preferably 75 vol % or more, and usually, for example, 95 vol % or less, or preferably 90 vol % or less.

When the proportion of the volume-based boron nitride particle content is below the above-described range, the boron nitride particles may not be oriented in a predetermined direction in the thermal conductive sheet. On the other hand, when the proportion of the volume-based boron nitride particle content exceeds the above-described range, the thermal conductive sheet may become fragile, and handleability and conformability to irregularities may be reduced.

The mixing ratio by mass of the boron nitride particles relative to 100 parts by mass of the total amount of the components (boron nitride particles and resin component) (total solid content) forming the thermal conductive sheet is, for example, 40 to 95 parts by mass, or preferably 65 to 90 parts by mass, and the mixing ratio by mass of the resin component relative to 100 parts by mass of the total amount of the components forming the thermal conductive sheet is, for example, 5 to 60 parts by mass, or preferably 10 to 35 parts by mass. The mixing ratio by mass of the boron nitride particles relative to 100 parts by mass of the resin component is, for example, 60 to 1900 parts by mass, or preferably 185 to 900 parts by mass.

When two epoxy resins (a first epoxy resin and a second epoxy resin) are used in combination, the mass ratio (mass of the first epoxy resin/mass of the second epoxy resin) of the first epoxy resin relative to the second epoxy resin can be set appropriately in accordance with the softening temperature and the like of the epoxy resins (the first epoxy resin and the second epoxy resin). For example, the mass ratio of the first epoxy resin relative to the second epoxy resin is 1/99 to 99/1, or preferably 10/90 to 90/10.

In the resin component, in addition to the above-described components (polymer), for example, a polymer precursor (for example, a low molecular weight polymer including oligomer), and/or a monomer are contained.

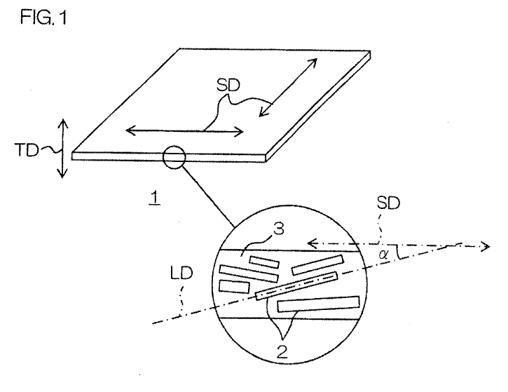

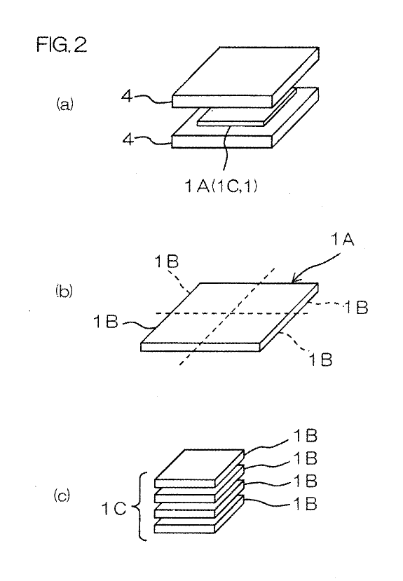

FIG. 1 shows a perspective view of an embodiment of a thermal conductive sheet of the present invention, and FIG. 2 shows process drawings for describing a method for producing the thermal conductive sheet shown in FIG. 1.

Next, a method for producing a thermal conductive sheet as an embodiment of the present invention is described with reference to FIG. 1 and FIG. 2.

In this method, first, the above-described components are blended at the above-described mixing ratio and are stirred and mixed, thereby preparing a mixture.

In the stirring and mixing, in order to mix the components efficiently, for example, the solvent can be blended therein with the above-described components, or, for example, the resin component (preferably, the thermoplastic resin component) can be melted by heating.

Examples of the solvent include the above-described organic solvents. When the above-described curing agent and/or the curing accelerator are prepared as a solvent solution and/or a solvent dispersion liquid, the solvent of the solvent solution and/or the solvent dispersion liquid can also serve as a mixing solvent for the stirring and mixing without adding a solvent during the stirring and mixing. Alternatively, in the stirring and mixing, a solvent can be further added as a mixing solvent.

In the case when the stirring and mixing is performed using a solvent, the solvent is removed after the stirring and mixing.

To remove the solvent, for example, the mixture is allowed to stand at room temperature for 1 to 48 hours; heated at 40 to 100° C. for 0.5 to 3 hours; or heated under a reduced pressure atmosphere of, for example, 0.001 to 50 kPa, at 20 to 60° C., for 0.5 to 3 hours.

When the resin component is to be melted by heating, the heating temperature is, for example, a temperature in the neighborhood of or exceeding the softening temperature of the resin component, to be specific, 40 to 150° C., or preferably 70 to 140° C.

Next, in this method, the obtained mixture is hot-pressed.

To be specific, as shown in FIG. 2(a), as necessary, for example, the mixture is hot-pressed with two releasing films 4 sandwiching the mixture, thereby producing a pressed sheet 1A. Conditions for the hot-pressing are as follows: a temperature of, for example, 50 to 150° C., or preferably 60 to 140° C.; a pressure of, for example, 1 to 100 MPa, or preferably 5 to 50 MPa; and a duration of, for example, 0.1 to 100 minutes, or preferably 1 to 30 minutes.

More preferably, the mixture is hot-pressed under vacuum. The degree of vacuum in the vacuum hot-pressing is, for example, 1 to 100 Pa, or preferably 5 to 50 Pa, and the temperature, the pressure, and the duration are the same as those described above for the hot-pressing.

When the temperature, the pressure, and/or the duration in the hot-pressing is outside the above-described range, there is a case where a porosity P (described later) of the thermal conductive sheet 1 cannot be adjusted to a desired value.

The pressed sheet 1A obtained by the hot-pressing has a thickness of, for example, 50 to 1000 μm, or preferably 100 to 800 μm.

Next, in this method, as shown in FIG. 2 (b), the pressed sheet 1A is divided into a plurality of pieces (for example, four pieces), thereby producing a divided sheet 1B (dividing step). In the division of the pressed sheet 1A, the pressed sheet 1A is cut along the thickness direction so that the pressed sheet 1A is divided into a plurality of pieces when the pressed sheet 1A is projected in the thickness direction. The pressed sheet 1A is cut so that the respective divided sheets 1B have the same shape when the divided sheets 1B are projected in the thickness direction.

Next, in this method, as shown in FIG. 2(c), the respective divided sheets 1B are laminated in the thickness direction, thereby producing a laminated sheet 1C (laminating step).

Thereafter, in this method, as shown in FIG. 2(a), the laminated sheet 1C is hot-pressed (preferably hot-pressed under vacuum) (hot-pressing step). The conditions for the hot-pressing are the same as the conditions for the above-described hot-pressing of the mixture.

The thickness of the hot-pressed laminated sheet 1C is, for example, 1 mm or less, or preferably 0.8 mm or less, and usually is, for example, 0.05 mm or more, or preferably 0.1 mm or more.

Thereafter, the series of the steps of the above-described dividing step (FIG. 2 (b)), laminating step (FIG. 2 (c)), and hot-pressing step (FIG. 2 (a)) are performed repeatedly, so as to allow boron nitride particles 2 to be efficiently oriented in a predetermined direction in the resin component 3 in the thermal conductive sheet 1. The number of the repetition is not particularly limited, and can be set appropriately according to the charging state of the boron nitride particles. The number of the repetition is, for example, 1 to 10 times, or preferably 2 to 7 times.

The thermal conductive sheet 1 can be obtained in this manner.

The thickness of the obtained thermal conductive sheet 1 is, for example, 1 mm or less, or preferably 0.8 mm or less, and usually, for example, 0.05 mm or more, or preferably 0.1 mm or more.

In the thermal conductive sheet 1, the proportion of the volume-based boron nitride particle content (solid content, that is, volume percentage of boron nitride particles relative to the total volume of the resin component and the boron nitride particles) is, as described above, for example, 35 vol % or more (preferably 60 vol % or more, or more preferably 75 vol % or more), and usually 95 vol % or less (preferably 90 vol % or less).

When the proportion of the boron nitride particle content is below the above-described range, the boron nitride particles may not be oriented in a predetermined direction in the thermal conductive sheet.

When the resin component 3 is the thermosetting resin component, a cured thermal conductive sheet 1 can also be produced by, for example, repeatedly performing the series of the steps of the above-described dividing step (FIG. 2 (b)), laminating step (FIG. 2 (c)), and hot-pressing step (FIG. 2 (a)) for an uncured (or semi-cured (in B-stage)) thermal conductive sheet 1; and then curing the uncured (or semi-cured (in B-stage)) thermal conductive sheet 1 by heat after the hot-pressing step (FIG. 2(a)), i.e., after the final step.

To cure the thermal conductive sheet 1 by heat, the above-described hot-press or a dryer is used. Preferably, a dryer is used. The conditions for the curing by heat are as follows: a temperature of, for example, 60 to 250° C., or preferably 80 to 200° C.

In the thus obtained thermal conductive sheet 1, as shown in FIG. 1 and its partially enlarged schematic view, the longitudinal direction LD of the boron nitride particle 2 is oriented along a plane (surface) direction SD that crosses (is perpendicular to) the thickness direction TD of the thermal conductive sheet 1.

The calculated average of the angle formed between the longitudinal direction LD of the boron nitride particle 2 and the plane direction SD of the thermal conductive sheet 1 (orientation angle α of the boron nitride particles 2 relative to the thermal conductive sheet 1) is, for example, 25 degrees or less, or preferably 20 degrees or less, and usually 0 degree or more.

The orientation angle α of the boron nitride particle 2 relative to the thermal conductive sheet 1 is obtained as follows: the thermal conductive sheet 1 is cut along the thickness direction with a cross section polisher (CP); the cross section thus appeared is photographed with a scanning electron microscope (SEM) at a magnification that enables observation of 200 or more boron nitride particles 2 in the field of view; a tilt angle α between the longitudinal direction LD of the boron nitride particle 2 and the plane direction SD (direction perpendicular to the thickness direction TD) of the thermal conductive sheet 1 is obtained from the obtained SEM photograph; and the average value of the tilt angles α is calculated.

Thus, the thermal conductivity in the plane direction SD of the thermal conductive sheet 1 is 4 W/m·K or more, preferably 5 W/m·K or more, more preferably 10 W/m·K or more, even more preferably 15 W/m·K or more, or particularly preferably 25 W/m·K or more, and usually 200 W/m·K or less.

The thermal conductivity in the plane direction SD of the thermal conductive sheet 1 is substantially the same before and after the curing by heat when the resin component 3 is the thermosetting resin component.

When the thermal conductivity in the plane direction SD of the thermal conductive sheet 1 is below the above-described range, thermal conductivity in the plane direction SD is insufficient, and therefore there is a case where the thermal conductive sheet 1 cannot be used for heat dissipation that requires thermal conductivity in such a plane direction SD.

The thermal conductivity in the plane direction SD of the thermal conductive sheet 1 is measured by a pulse heating method. In the pulse heating method, the xenonflash analyzer “LFA-447” (manufactured by Erich NETZSCH GmbH & Co. Holding KG) is used.

The thermal conductivity in the thickness direction TD of the thermal conductive sheet 1 is, for example, 0.5 to 15 W/m·K, or preferably 1 to 10 W/m·K.

The thermal conductivity in the thickness direction TD of the thermal conductive sheet 1 is measured by a pulse heating method, a laser flash method, or a TWA method. In the pulse heating method, the above-described device is used, in the laser flash method, “TC-9000” (manufactured by Ulvac, Inc.) is used, and in the TWA method, “ai-Phase mobile” (manufactured by ai-Phase Co., Ltd) is used.

Thus, the ratio of the thermal conductivity in the plane direction SD of the thermal conductive sheet 1 relative to the thermal conductivity in the thickness direction TD of the thermal conductive sheet 1 (thermal conductivity in the plane direction SD/thermal conductivity in the thickness direction TD) is, for example, 1.5 or more, preferably 3 or more, or more preferably 4 or more, and usually 20 or less.

Although not shown in FIG. 1, for example, pores (gaps) are formed in the thermal conductive sheet 1.

The proportion of the pores in the thermal conductive sheet 1, that is, a porosity P, can be adjusted by setting the proportion of the boron nitride particle 2 content (volume-based), and further setting the temperature, the pressure, and/or the duration at the time of hot pressing the mixture of the boron nitride particle 2 and the resin component 3 (FIG. 2(a)). To be specific, the porosity P can be adjusted by setting the temperature, the pressure, and/or the duration of the hot pressing (FIG. 2(a)) within the above-described range.

The porosity P of the thermal conductive sheet 1 is, for example, 30 vol % or less, or preferably 10 vol % or less.

The porosity P is measured by, for example, as follows: the thermal conductive sheet 1 is cut along the thickness direction with a cross section polisher (CP); the cross section thus appeared is observed with a scanning electron microscope (SEM) at a magnification of 200 to obtain an image; the obtained image is binarized based on the pore portion and the non-pore portion; and the area ratio, i.e., the ratio of the pore portion area to the total area of the cross section of the thermal conductive sheet 1 is determined by calculation.

The thermal conductive sheet 1 has a porosity P2 after curing of, relative to a porosity P1 before curing, for example, 100% or less, or preferably 50% or less.

For the measurement of the porosity P(P1), when the resin component 3 is a thermosetting resin component, the thermal conductive sheet 1 before curing by heat is used.

When the porosity P of the thermal conductive sheet 1 is within the above-described range, the conformability to irregularities (described later) of the thermal conductive sheet 1 can be improved.

The thermal conductive sheet 1 has a volume resistivity R of 1×10¹⁰ Ω·cm or more, preferably 1×10¹²Ω·cm or more, and usually 1×10²⁰Ω·cm or less.

The volume resistivity R of the thermal conductive sheet 1 is measured in conformity with JIS K 6911 (thermosetting plastic general testing method, 2006).

When the thermal conductive sheet 1 has a volume resistivity R below the above-described range, there is a case where short circuits between the electron devices to be described later cannot be prevented.

When the resin component 3 is a thermosetting resin component in the thermal conductive sheet 1, the volume resistivity R is a value of a cured thermal conductive sheet 1.

When the thermal conductive sheet 1 is evaluated in the bend test in conformity with the cylindrical mandrel method of JIS K 5600-5-1 under the test conditions shown below, preferably, no fracture is observed.

### Test Conditions:

Test Device: Type I

Mandrel: diameter 10 mm

Bending Angle: 90 degrees or more

Thickness of the thermal conductive sheet 1: 0.3 mm

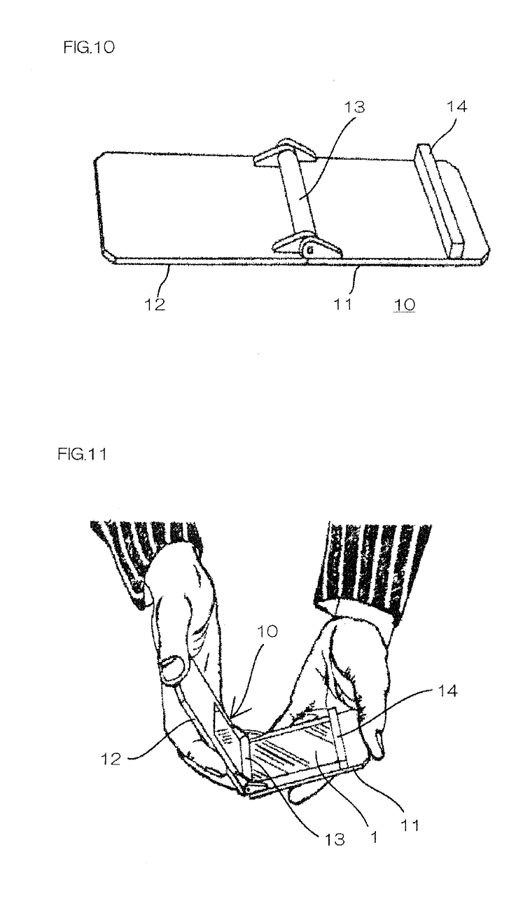

FIGS. 10 and 11 show perspective views of the Type I test device. In the following, the Type I test device is described.

In FIGS. 10 and 11, a Type I test device 10 includes a first flat plate 11; a second flat plate 12 disposed in parallel with the first flat plate 11; and a mandrel (rotation axis) 13 provided for allowing the first flat plate 11 and the second flat plate 12 to rotate relatively.

The first flat plate 11 is formed into a generally rectangular flat plate. A stopper 14 is provided at one end portion (free end portion) of the first flat plate 11. The stopper 14 is formed on the surface of the second flat plate 12 so as to extend along the one end portion of the second flat plate 12.

The second flat plate 12 is formed into a generally rectangular flat plate, and one side thereof is disposed so as to be adjacent to one side (the other end portion (proximal end portion) that is opposite to the one end portion where the stopper 14 is provided) of the first flat plate 11.

The mandrel 13 is formed so as to extend along one side of the first flat plate 11 and one side of the second flat plate 12 that are adjacent to each other.

In the Type I test device 10, as shown in FIG. 10, the surface of the first flat plate 11 is flush with the surface of the second flat plate 12 before the start of the bend test.

To perform the bend test, the thermal conductive sheet 1 is placed on the surface of the first flat plate 11 and the surface of the second flat plate 12. The thermal conductive sheet 1 is placed so that one side of the thermal conductive sheet 1 is in contact with the stopper 14.

Then, as shown in FIG. 11, the first flat plate 11 and the second flat plate 12 are rotated relatively. In particular, the free end portion of the first flat plate 11 and the free end portion of the second flat plate 12 are rotated to a predetermined angle with the mandrel 13 as the center. To be specific, the first flat plate 11 and the second flat plate 12 are rotated so as to bring the surface of the free end portions thereof closer (oppose each other).

In this way, the thermal conductive sheet 1 is bent with the mandrel 13 as the center, conforming to the rotation of the first flat plate 11 and the second flat plate 12.

More preferably, no fracture is observed in the thermal conductive sheet 1 even when the bending angle is set to 180 degrees under the above-described test conditions.

When the resin component 3 is the thermosetting resin component, a semi-cured (in B-stage) thermal conductive sheet 1 (that is, the thermal conductive sheet 1 before curing by heat) is tested in the bend test.

When the fracture is observed in the bend test at the above bending angle in the thermal conductive sheet 1, there is a case where excellent flexibility cannot be given to the thermal conductive sheet 1.

Furthermore, the thermal conductive sheet 1 has a transmittance of light of 10% or less at a wavelength of 500 nm, when the thermal conductive sheet 1 is formed to have a thickness of 300 μm. When the transmittance of the thermal conductive sheet 1 having a thickness of 300 μm exceeds the above-described range, excellent hiding characteristics cannot be ensured.

The transmittance of light of the thermal conductive sheet 1 at a wavelength of 500 nm is measured in conformity with the description of HS K 7361-1(1997) “Plastics—Determination of the total luminous transmittance of transparent materials”. In particular, the measurement is conducted by using a spectrophotometer equipped with an integrating sphere.

The thermal conductive sheet 1 with a thickness of 300 μm has a transmittance of light at a wavelength of 500 nm of, preferably, 8% or less.

The transmittance of light at a wavelength of 500 nm of the thermal conductive sheet 1 is substantially the same before and after the curing by heat of the thermal conductive sheet 1 when the resin component 3 is a thermosetting resin component.

The thermal conductive sheet 1 has a surface reflectance R of light at 500 nm of, 70% or more, preferably, 75% or more, or more preferably 80% or more, and usually has a surface reflectance R of light at 500 nm of 100% or less.

The surface reflectance R of light at 500 nm of the thermal conductive sheet 1 is represented by a percentage relative to the surface reflectance of light at 500 nm of barium sulfate as 100%.

The surface reflectance R is measured with a spectrophotometer, and in the measurement with the spectrophotometer, an integrating sphere is used and the measurement is performed at an incident angle of 5 degrees.

When the surface reflectance R of the thermal conductive sheet 1 is below the above-described range, light at 500 nm emitted from a light-emitting diode 27 to be described later may not be reflected efficiently.

When the resin component 3 is a thermosetting resin component in the thermal conductive sheet 1, the surface reflectance R is a value for the cured thermal conductive sheet 1.

Furthermore, for example, when the thermal conductive sheet 1 is evaluated in the 3-point bending test in conformity with JIS K 7171 (2008) under the test conditions shown below, no fracture is observed.

### Test Conditions:

Test piece: size 20 mm×15 mm

Distance between supporting points: 5 mm

Testing speed: 20 mm/min (indenter depressing speed)

Bending angle: 120 degrees

Evaluation method: Presence or absence of fracture such as cracks at the center of the test piece is observed visually when tested under the above-described test conditions.

In the 3-point bending test, when the resin component 3 is a thermosetting resin component, the thermal conductive sheet 1 before curing by heat is used.

Therefore, the thermal conductive sheet 1 is excellent in conformability to irregularities because no fracture is observed in the above-described 3-point bending test. The conformability to irregularities is, when the thermal conductive sheet 1 is provided on an object with irregularities, a property of the thermal conductive sheet 1 that conforms to be in close contact with the irregularities.

A mark such as, for example, letters and symbols can be given to the thermal conductive sheet 1. That is, the thermal conductive sheet 1 is excellent in mark adhesion. The mark adhesion is a property of the thermal conductive sheet 1 that allows reliable adhesion of the above-described mark thereon.

The mark can be adhered (applied, fixed, or firmly fixed) to the thermal conductive sheet 1, to be specific, by printing, engraving, or the like.

Examples of printing include, for example, inkjet printing, relief printing, intaglio printing, and laser printing.

When the mark is to be printed by inkjet printing, relief printing, or intaglio printing, for example, an ink fixing layer for improving mark's fixed state can be provided on the surface (printing side) of the thermal conductive sheet 1.

When the mark is to be printed by laser printing, for example, a toner fixing layer for improving mark's fixed state can be provided on the surface (printing side) of the thermal conductive sheet 1.

Examples of engraving include laser engraving and punching.

In the above-described hot-pressing step (FIG. 2 (a)), for example, a plurality of calendering rolls and the like can also be used for rolling the mixture and the laminated sheet 1C.

The above-described thermal conductive sheet 1 is excellent in thermal conductivity in the plane direction SD, and also excellent in electrical insulation.

Therefore, by covering the electron devices with the thermal conductive sheet 1, the electron devices can be protected, the heat from the electron devices can be conducted efficiently, and a short circuit between the electron devices can be prevented.

The electron devices are not particularly limited, and examples thereof include IC (integrated circuit) chips, condensers, coils, resistors, and light-emitting diodes. These electron devices are usually provided on a substrate, and are arranged with a space provided therebetween in the plane direction (plane direction of the substrate).

To cover the electron devices with the thermal conductive sheet 1, to be specific, when the resin component is a thermosetting resin component, an uncured (or in B-stage) thermal conductive sheet 1 is disposed on the surface of the electron devices, and then the thermal conductive sheet 1 is cured by heat thereafter. In this way, the electron devices are covered with the thermal conductive sheet 1.

The above-described thermal conductive sheet 1 is excellent in thermal conductivity in the plane direction SD, and also excellent in hiding characteristics.

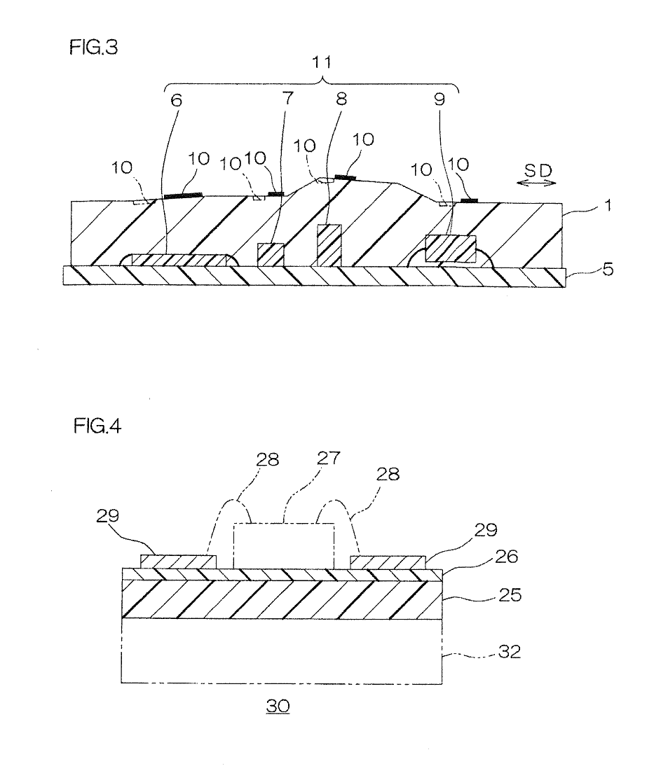

Therefore, as shown in FIG. 3, for example, even if the surface of the thermal conductive sheet 1 is observed in the following case, the electronic components 11 are hidden by the thermal conductive sheet 1: the thermal conductive sheet 1 is bonded to the surface of the electronic components 11 to be used in power electronics to cover the electronic components 11, and then a mark 10 is formed (adhered) on the surface of the thermal conductive sheet 1. Therefore, without visually recognizing the electronic components 11, only the mark 10 can be visually recognized.

As a result, the mark 10 can be clearly identified, and the heat of the electronic components 11 can be dissipated along the plane direction SD of the thermal conductive sheet 1.

The electronic components 11 include, as shown in FIG. 3, for example, an IC (integrated circuit) chip 6, a condenser 7, a coil 8, and/or a resistor 9. Although not shown in FIG. 3, other than the above-described electronic components 11, for example, a light-emitting diode can be included as well.

The above-described electronic components 11 are mounted on the surface (one side) of the mounting substrate 5, and on the mounting substrate 5, the electronic components 11 are disposed in the plane direction (plane direction SD of the mounting substrate 5) with a space provided therebetween.

The mark 10 indicates infoi nation such as a product number and/or the date of manufacture of the electronic components 11. The mark 10 is formed on the surface of the cured thermal conductive sheet 1, which is bonded to, when the resin component is a thermosetting resin component, the electronic components 11, and then thereafter cured by heat, for example, by printing or stamping with an ink. The color of the ink is not particularly limited. The mark 10 can be formed from, other than the ink, for example, a material for pencil core, which is usually a mixture of graphite and clay, and in such a case, the mark 10 is formed from the core material using a pencil.

The mark 10 can also be formed, for example, when the resin component is a thermosetting resin component, as indicated by the phantom line in FIG. 3, as a recessed portion, by forming a recessed portion by the above-described engraving on the surface of the thermal conductive sheet 1 that was after bonded to the electronic components 11 but before curing (uncured), for example, and then thereafter curing the thermal conductive sheet 1. Examples of the engraving include, for example, nicking (punching) or laser processing (laser engraving).

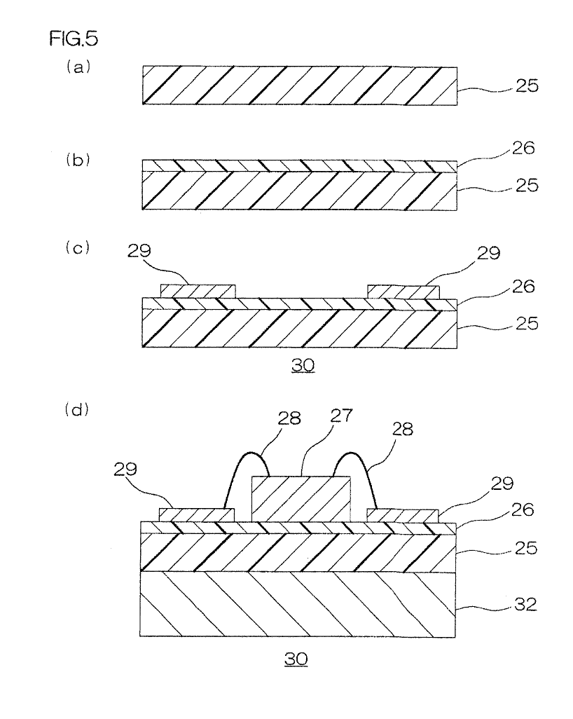

FIG. 4 shows a cross sectional view of a light-emitting diode mounting substrate including a thermal conductive light reflection layer composed of the thetinal conductive sheet shown in FIG. 1; FIG. 5 shows process drawings for describing a method for producing a light-emitting diode mounting substrate, and a method for mounting a light-emitting diode.

In the following, an embodiment of the light-emitting diode mounting substrate of the present invention is described with reference to FIG. 4 and FIG. 5.

In FIG. 4 and FIG. 5(c), the light-emitting diode mounting substrate 30 includes a substrate 25, and a thermal conductive light reflection layer 26 formed on the surface of the substrate 25.

The substrate 25 is formed into a flat plate, and is formed from the component that is the same as that of the above-described resin component. As shown by the phantom line of FIG. 4, on the substrate 25, a light-emitting diode 27 (ref. FIG. 5(d)) is mounted with the thermal conductive light reflection layer 26 interposed therebetween.

The thermal conductive light reflection layer 26 is composed of the above-described thermal conductive sheet 1, and is formed on the entire top face of the substrate 25.

In the light-emitting diode mounting substrate 30, a wiring 29 and a heat dissipation member 32 are provided (ref. FIG. 4 and FIG. 5(d)).

The wiring 29 is formed on the top face of the thermal conductive light reflection layer 26, and formed into a pattern that allows electrical connection with the light-emitting diode 27. The wiring 29 is formed, for example, from a conductive material such as copper, gold, and the like.

The heat dissipation member 32 is, for example, a heat sink, and is provided so as to contact the entire bottom face of the substrate 25.

To produce the light-emitting diode mounting substrate 30, first, as shown in FIG. 5(a), the substrate 25 is prepared, and then, as shown in FIG. 5(b), the thermal conductive light reflection layer 26 is formed on the surface of the substrate 25.

To form the thermal conductive light reflection layer 26, for example, when the resin component is a thermosetting resin component, a thermal conductive sheet 1 in B-stage is placed on the entire top face of the substrate 25, and thereafter, the thermal conductive sheet 1 is cured by heat, thereby allowing the thermal conductive sheet 1 to adhere to the top face of the substrate 25.

Then, as shown in FIG. 5(c), the wiring 29 is formed on the surface of the thermal conductive sheet 1 by a known wiring forming method.

The light-emitting diode mounting substrate 30 is obtained in this manner.

Thereafter, the light-emitting diode 27 is mounted on the obtained light-emitting diode mounting substrate 30.

To mount the light-emitting diode 27 on the light-emitting diode mounting substrate 30, as shown in FIG. 5(d), first, the light-emitting diode 27 is placed on the top face of the thermal conductive light reflection layer 26, and thereafter, the light-emitting diode 27 and the wiring 29 are connected (wire bonded) using a wire 8.

On the bottom face of the light-emitting diode mounting substrate 30, the heat dissipation member 32 is provided.

The above-described thermal conductive sheet 1 is excellent in thermal conductivity in the plane direction SD, and excellent in surface reflectance R.

Therefore, by mounting the light-emitting diode 27 on the light-emitting diode mounting substrate 30 including the thermal conductive light reflection layer 26 composed of the thermal conductive sheet 1, light emitted from the light-emitting diode 27 can be efficiently reflected upward in the thermal conductive light reflection layer 26, and heat generated from the light-emitting diode 27 can be efficiently conducted in the plane direction SD by the thermal conductive light reflection layer 26.

In particular, in the case of a light-emitting diode 27 having a small mounting area, a portion of the substrate 25 where the light-emitting diode 27 is mounted locally has high temperature. However, with the above-described light-emitting diode mounting substrate 30, heat generation from the light-emitting diode 27 can be dispersed (spread) in the plane direction in the thermal conductive light reflection layer 26, and further can be dispersed from the thermal conductive light reflection layer 26 to the heat dissipation member 32. Therefore, heat from the light-emitting diode 27 can be conducted efficiently to the heat dissipation member 32 through the thermal conductive light reflection layer 26.

As a result, decrease in luminous efficacy of the light-emitting diode mounting substrate 30 can be reliably prevented.

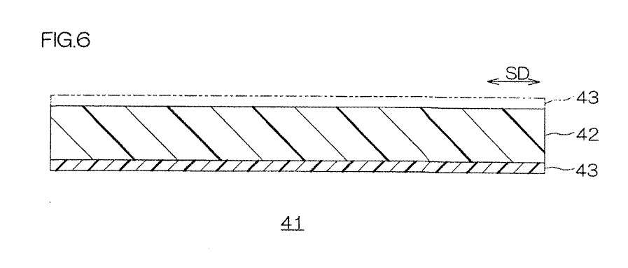

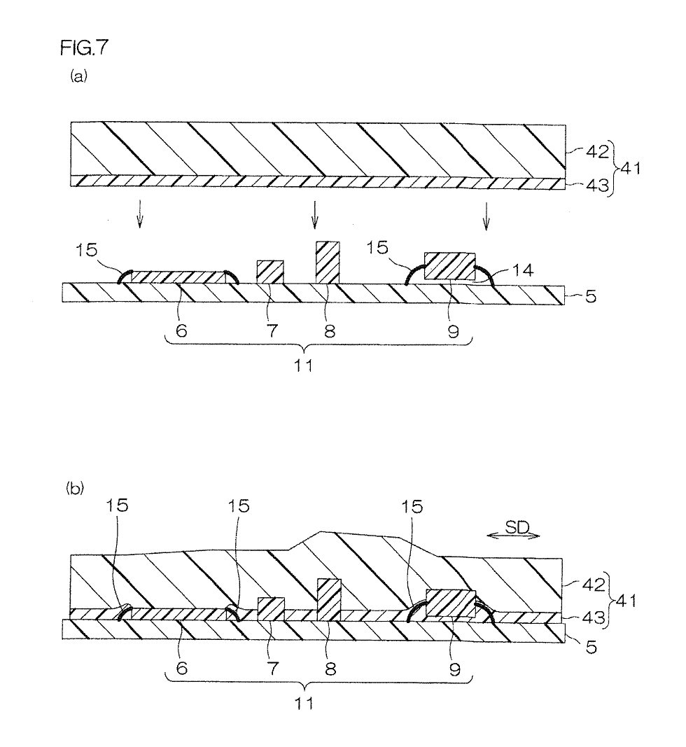

FIG. 6 is a cross sectional view of an embodiment of the thermal conductive adhesive sheet of the present invention, and FIG. 7 shows process drawings for describing a method for allowing the thermal conductive adhesive sheet shown in FIG. 6 to adhere to or pressure-sensitively adhered to the electronic components and the mounting substrate.

In the following, a thermal conductive adhesive sheet including the above-described thermal conductive adhesive sheet as the thermal conductive layer is described with reference to FIG. 6 and FIG. 7.

In FIG. 6, the thermal conductive adhesive sheet 41 includes a thermal conductive layer 42, and an adhesive layer 43 or pressure-sensitive adhesive layer 43 (in the following, these are sometimes called “adhesive/pressure-sensitive adhesive layer 43”) laminated on the surface of the thermal conductive layer 42.

The thermal conductive layer 42 is formed into a flat plate sheet, and composed of the above-described thermal conductive adhesive sheet 41.

The adhesive/pressure-sensitive adhesive layer 43 is formed, as shown in FIG. 6, on the entire bottom face of the thermal conductive layer 42.

The adhesive/pressure-sensitive adhesive layer 43 is composed of an adhesive having flexibility and adhesiveness or pressure-sensitive adhesiveness (tackiness) under a normal temperature atmosphere and a heated atmosphere, and is capable of exhibiting adhesive effects by heating or by cooling after the heating; or a pressure-sensitive adhesive having flexibility and adhesiveness or pressure-sensitive adhesiveness (tackiness) under a normal temperature atmosphere and a heated atmosphere, and is capable of exhibiting pressure-sensitive adhesive effects (effects of pressure-sensitive adhesion, that is, pressure-sensitive adhesion effects) by heating or cooling after the heating. Examples of the adhesive include, for example, thermosetting adhesive, and hot-melt adhesive.

The thermosetting adhesive adheres to an adherend by being cured by heat and solidified. Examples of the thermosetting adhesive include, for example, epoxy thermosetting adhesive, urethane thermosetting adhesive, and acrylic thermosetting adhesive. Preferably, the epoxy thermosetting adhesive is used.

The curing temperature of the thermosetting adhesive is, for example, 100 to 200° C.

The hot-melt adhesive adheres to an adherend by being melted or softened by heat, thereby heat-fused to the adherend, and then solidified by cooling thereafter. Examples of the hot-melt adhesive include, for example, rubber hot-melt adhesive, polyester hot-melt adhesive, and olefin hot-melt adhesive. Preferably, rubber hot-melt adhesive is used.

The hot-melt adhesive has a softening temperature (ring and ball method) of, for example, 100 to 200° C. The hot-melt adhesive has a melt viscosity at 180° C. of, for example, 100 to 30,000 mPa·s.

The above-described adhesive can also contain, as necessary, for example, thermal conductive particles.

Examples of the thermal conductive particle include, for example, thermal conductive inorganic particles and thermal conductive organic particles. Preferably, thermal conductive inorganic particles are used.

Examples of the thermal conductive inorganic particles include nitride particles such as boron nitride particles, aluminum nitride particles, silicon nitride particles, and gallium nitride particles; hydroxide particles such as aluminum hydroxide particles and magnesium hydroxide particles; oxide particles such as silicon oxide particles, aluminum oxide particles, titanium oxide particles, zinc oxide particles, tin oxide particles, copper oxide particles, and nickel oxide particles; carbide particles such as silicon carbide particles; carbonate particles such as calcium carbonate particles; metallate (metal salts of acids) particles such as titanate particles including barium titanate particles and potassium titanate particles; and metal particles such as copper particles, silver particles, gold particles, nickel particles, aluminum particles, and platinum particles.

These thermal conductive particles can be used alone or in combination of two or more.

Examples of the shape or form of the thermal conductive particle include a bulk form, a needle shape, a plate shape, a layered form, and a tube shape. The thermal conductive particles have an average particle size of, for example, 0.1 to 1000 μm.

The thermal conductive particles have, for example, anisotropic thermal conductivity or isotropic thermal conductivity. Preferably, the thermal conductive particles have isotropic thermal conductivity.

The thermal conductive particles have a thermal conductivity of, for example, 1 W/m·K or more, preferably 2 W/m·K or more, or more preferably 3 W/m·K or more, and usually 1000 W/m·K or less.

The mixing ratio of the thermal conductive particle is, for example, 0.01 to 10 parts by mass per 100 parts by mass of the adhesive.

When the thermal conductive particles are to be blended into the adhesive, the thermal conductive particles are added to the adhesive at the above-described mixing ratio, and the mixture is stirred to be mixed.

The adhesive is prepared as a thermal conductive adhesive.

The thermal conductive adhesive has a thermal conductivity of, for example, 0.01 W/m·K or more, and usually has a thermal conductivity of 100 W/m·K or less.

Examples of the pressure-sensitive adhesive include, for example, rubber pressure-sensitive adhesive and silicone pressure-sensitive adhesive. Furthermore, the pressure-sensitive adhesive can also be prepared as a thermal conductive pressure-sensitive adhesive by allowing the pressure-sensitive adhesive to contain the above-described thermal conductive particle at a proportion that is the same as the above-described proportion. The thermal conductivity of the thermal conductive pressure-sensitive adhesive is the same as the thermal conductivity of the above-described thermal conductive adhesive.

The adhesive/pressure-sensitive adhesive layer 43 has a thickness of, for example, 10 to 500 μm, or preferably 20 to 200 μm.

To obtain the thermal conductive adhesive sheet 41, the above-described thermal conductive layer 42 is prepared, and then the adhesive/pressure-sensitive adhesive layer 43 is laminated on the surface of the thermal conductive layer 42.

A varnish is prepared by blending the above-described solvent in the adhesive (to be specific, thermosetting adhesive) or pressure-sensitive adhesive, and the varnish is applied on the surface of the separator. Thereafter, the organic solvent in the varnish is distilled away, by drying under normal pressure or under vacuum (reduced pressure). The solid content concentration of the varnish is, for example, 10 to 90% by mass.

Thereafter, the adhesive/pressure-sensitive adhesive layer 43 is bonded to the thermal conductive layer 42. When the adhesive/pressure-sensitive adhesive layer 43 and the thermal conductive layer 42 are bonded, as necessary, they are pressure bonded or thermocompression bonded.

Next, a method for allowing the thermal conductive adhesive sheet 41 to adhere to the electronic components 11 and the mounting substrate 5 is described with reference to FIG. 7.

First, in this method, as shown in FIG. 7(a), the thermal conductive adhesive sheet 41 and the mounting substrate 5 are prepared.

On the surface (top face) of the mounting substrate 5, the above-described electronic components 11 are mounted.

Then, in this method, as shown in FIG. 7(b), the thermal conductive adhesive sheet 41 is thermocompression bonded to the electronic components 11 and the mounting substrate 5.

To be specific, first, the thermal conductive adhesive sheet 41 and the mounting substrate 5 are disposed so that the adhesive/pressure-sensitive adhesive layer 43 faces the electronic components 11, and then these are brought into contact with each other. While the thermal conductive adhesive sheet 41 is heated, the thermal conductive adhesive sheet 41 is pressure bonded toward the mounting substrate 5 (pressed, thermocompression bonding).

In the pressure bonding, for example, while a sponge roll made of a resin such as silicone resin is pressed against the thermal conductive adhesive sheet 41, the sponge roll is rolled on the back face of the thermal conductive adhesive sheet 41 (top face of the thermal conductive layer 42).

The heating temperature is, for example, 40 to 120° C.

In this thermocompression bonding, flexibility of the adhesive/pressure-sensitive adhesive layer 43 improves, and therefore, the electronic components 11 that protrude from the surface (top face) to a front side (upper side) of the mounting substrate 5 penetrate through the adhesive/pressure-sensitive adhesive layer 43, and the surface (top face) of the electronic components 11 is brought into contact with the surface (bottom face) of the thermal conductive layer 42. The gap (e.g., the gap between the resistor 9 and the mounting substrate 5) 14 formed around the electronic components 11 is filled with the adhesive/pressure-sensitive adhesive layer 43. Further more, the adhesive/pressure-sensitive adhesive layer 43 is entangled with and covers a terminal which is not shown, and/or a wire 15, for connecting the electronic components 11 (to be specific, IC chip 6 and resistor 9) and the mounting substrate 5.

To be specific, the top face and an upper portion of the side face of the electronic components 11 are covered with the thermal conductive layer 42.

On the other hand, the side face (a lower portion of the side face) of the electronic components 11 is covered (adhered to or pressure-sensitively adhered to) with the adhesive/pressure-sensitive adhesive layer 43 that is penetrated by the electronic components 11.

To be more specific, in thermocompression bonding, when the resin component 3 is a thermosetting resin component, the resin component 3 is in B-stage, and therefore the thermal conductive layer 42 is pressure-sensitively adhered to the surface (top face) of the mounting substrate 5 exposed from the electronic components 11. Furthermore, when the electronic components 11 have a thickness that is larger than that of the adhesive/pressure-sensitive adhesive layer 43, the upper portion of the electronic components 11 enters into the thermal conductive layer 42 toward the inner portion from the surface of the thermal conductive layer 42.

When the adhesive is a hot-melt adhesive, the above-described thermocompression bonding allows the adhesive/pressure-sensitive adhesive layer 43 to be melted or softened, allowing the adhesive/pressure-sensitive adhesive layer 43 to be heat-fused on the surface of the mounting substrate 5 and the side face of the electronic components 11. Then, by allowing the thermal conductive adhesive sheet 41 to stand at normal temperature to be cooled, the adhesive/pressure-sensitive adhesive layer 43 adheres to the surface of the mounting substrate 5 and the side face of the electronic components 11.

On the other hand, when the adhesive layer in the adhesive/pressure-sensitive adhesive layer 43 is a thermosetting adhesive, the above-described thermocompression bonding allows the adhesive to be in B-stage, and the mounting substrate 5 and the electronic components 11 are temporarily fixed to the thermal conductive adhesive sheet 41. Then, by further heating the thermal conductive adhesive sheet 41, the adhesive/pressure-sensitive adhesive layer 43 is cured by heat, and adheres to the surface of the mounting substrate 5 and the side face of the electronic component 11.

To cure the adhesive/pressure-sensitive adhesive layer 43 by heat, a hot press or a dryer is used. Preferably, a dryer is used. Conditions for the curing by heat are as follows: a heating temperature of, for example, 100 to 250° C., or preferably 120 to 200° C., and a duration of, for example, 10 to for 200 minutes, or preferably 60 to for 150 minutes.

When the resin component 3 in the thermal conductive layer 42 is a thermosetting resin component, at the same time with the heat fusing and/or curing by heat of the adhesive/pressure-sensitive adhesive layer 43, an uncured thermal conductive layer 42 is cured by heat.

The above-described thermal conductive adhesive sheet 41 is excellent in the thermal conductivity in the plane direction SD, and also excellent in adhesiveness or pressure-sensitive adhesiveness.

Therefore, the thermal conductive adhesive sheet 41 allows adhesion or pressure-sensitive adhesion to the mounting substrate 5 and the electronic components 11 with excellent adhesiveness or pressure-sensitive adhesiveness, and dissipation of the heat from the electronic components 11 in the plane direction SD.

In particular, even if the mounting substrate 5 and the electronic components 11 undergo vibration, repetitive stress, and/or heat cycle (step of repetitive heating and cooling) for a long period of time, the thermal conductive adhesive sheet 41 can be used for the above-described adhesion and heat dissipation of the mounting substrate 5 and the electronic components 11 that require durability.

Furthermore, in the above-described thermal conductive adhesive sheet 41, the adhesive/pressure-sensitive adhesive layer 43 is formed on the entire surface of the thermal conductive layer 42, and the electronic components 11 penetrate the adhesive/pressure-sensitive adhesive layer 43, and therefore the thermal conductive adhesive sheet 41 does not have to be precisely positioned relative to the electronic components 11, and thermocompression bonding may be performed after the thermal conductive adhesive sheet 41 is disposed to face the mounting substrate 5. Therefore, the thermal conductive adhesive sheet 41 can easily be adhered to or pressure-sensitively adhered to the electronic component 11.

When the adhesive/pressure-sensitive adhesive layer 43 is formed on the entire surface of the thermal conductive layer 42, preferably, the adhesive/pressure-sensitive adhesive layer 43 is formed from a thermal conductive adhesive or a thermal conductive pressure-sensitive adhesive.

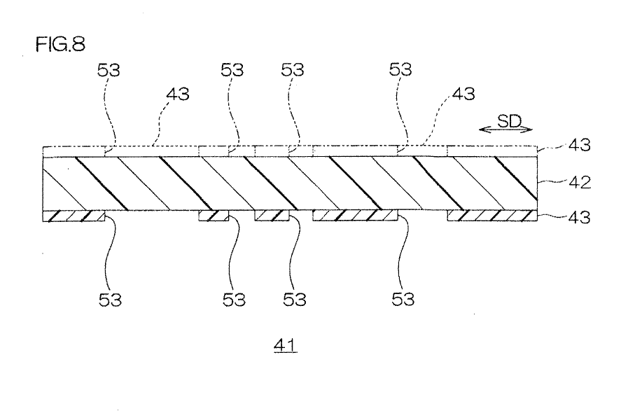

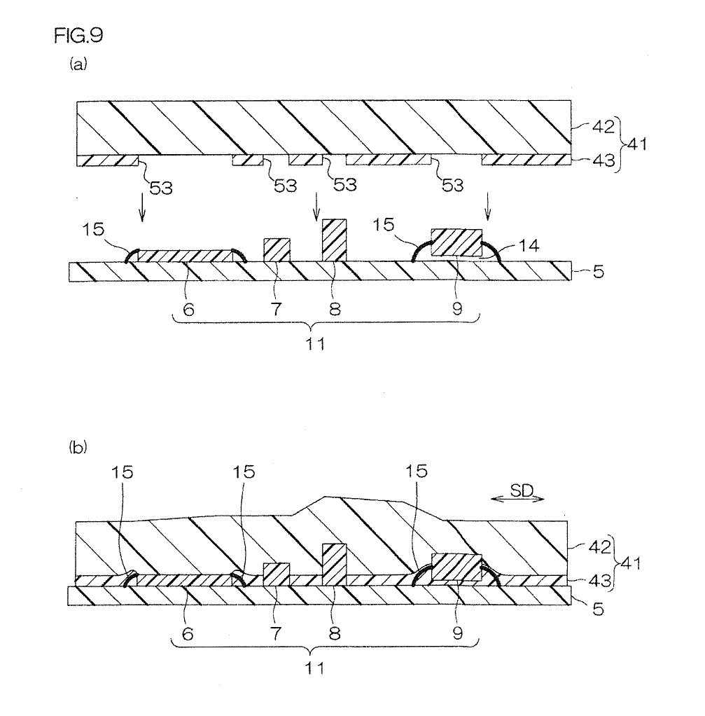

FIG. 8 shows a cross sectional view of another embodiment (embodiment in which an opening is formed in the adhesive/pressure-sensitive adhesive layer) of the thermal conductive adhesive sheet of the present invention; and FIG. 9 shows process drawings for describing a method for allowing the thermal conductive adhesive sheet shown in FIG. 8 to adhere to or pressure-sensitively adhere to the electronic components and the mounting substrate.

In the following figures, the same reference numerals are used for the members that are the same as the members in the above, and detailed descriptions thereof are omitted.

Although the adhesive/pressure-sensitive adhesive layer 43 is formed on the entire surface of the thermal conductive layer 42 in the description with reference to FIG. 6 and FIG. 7(a), for example, as shown in FIG. 8 and FIG. 9(a), the adhesive/pressure-sensitive adhesive layer 43 can also be formed on a portion of the surface of the thermal conductive layer 42.

In FIG. 8, in the adhesive/pressure-sensitive adhesive layer 43, openings 53 that penetrate in the thickness direction thereof are formed.

The openings 53 are formed in the adhesive/pressure-sensitive adhesive layer 43, in a pattern that matches the electronic components 11. That is, the openings 53 are formed so as to have the same outline shape with the electronic components 11 when the openings 53 are disposed to face the mounting substrate 5 and projected in the thickness direction. That is, the openings 53 are formed in a pattern that fits the electronic components 11 in the pressure bonding of the thermal conductive adhesive sheet 41 to the mounting substrate 5 to be described later.

The adhesive/pressure-sensitive adhesive layer 43 is formed from, preferably, an adhesive or a pressure-sensitive adhesive that does not contain a thermal conductive particle.

To laminate the adhesive layer 43 onto the surface of the thermal conductive layer 42, the adhesive/pressure-sensitive adhesive is applied or thermocompression bonded to the surface of the thermal conductive layer 42 with a mask (not shown) having a pattern that is the same as the openings 53 interposed therebetween, and thereafter, the mask is removed. The mask is formed, for example, from a metal material such as stainless steel, and as necessary, the back face (facing the thermal conductive layer 42) is treated with a silicone compound for removal purpose. The mask has a thickness of, for example, 10 to 1000 μm.

To adhere or pressure-sensitively adhere the thermal conductive adhesive sheet 41 including the adhesive/pressure-sensitive adhesive layer 43 having the openings 53 to the mounting substrate 5 and the electronic components 11, first, as shown in FIG. 9(a), the thermal conductive adhesive sheet 41, and the mounting substrate 5 are prepared, and then as shown in FIG. 9(b), the thermal conductive adhesive sheet 41 is thermocompression bonded to the mounting substrate 5.

In the thermocompression bonding of the thermal conductive adhesive sheet 41, the thermal conductive adhesive sheet 41 is positioned relative to the electronic components 11 so that the electronic components 11 and the openings 53 of the adhesive layer 43 are at the same position when projected in the thickness direction, and then while the thermal conductive adhesive sheet 41 is being heated, the electronic components 11 are charged and stored in the openings 53 of the adhesive/pressure-sensitive adhesive layer 43 so that the electronic components 11 are fitted in the openings 53.

Thus, the thermal conductive layer 42 is reliably brought into contact with the top face (and upper side side face) of the electronic components 11, thereby allowing direct adhesion or pressure-sensitive adhesion.

As a result, heat of the electronic components 11 can be reliably dissipated along the plane direction SD.

In the above-description, the openings 53 that penetrate in the thickness direction are formed in the adhesive/pressure-sensitive adhesive layer 43. However, for example, instead of the openings 53, although not shown, recessed portions that are recessed inwardly from the surface of the adhesive/pressure-sensitive adhesive layer 43 can also be formed so as to correspond to the thickness of the electronic components 11.

Although the adhesive/pressure-sensitive adhesive layer 43 is laminated onto one side of the thermal conductive layer 42 in the description above, for example, as shown by the phantom line in FIG. 6 and shown by the phantom line in FIG. 8, the adhesive/pressure-sensitive adhesive layer 43 can also be formed on both sides of the thermal conductive adhesive sheet 41 (top face and bottom face).

Although the adhesive/pressure-sensitive adhesive layer 43 is laminated onto the entire surfaces of the both sides of the thermal conductive layer 42 (phantom line in FIG. 6), or the adhesive/pressure-sensitive adhesive layer 43 is laminated onto a portion of the both sides of the thermal conductive layer 42 (phantom line in FIG. 8) in the description above, for example, as shown by the solid line and broken line in FIG. 8, the adhesive/pressure-sensitive adhesive layer 43 can also be formed on the entire top face (broken line, entirely on one side) of the thermal conductive layer 42 and also be formed on a portion of the bottom face (solid line, partially on the other side) of the thermal conductive layer 42.

### EXAMPLES

Hereinafter, the present invention is described in further detail with reference to Preparation Examples and Examples. However, the Present Invention is not Limited to Those.

### Example 1

The components described below were blended, stirred, and allowed to stand at room temperature (23° C.) for one night, thereby allowing methyl ethyl ketone (solvent for the curing agent) to volatilize and preparing a semi-solid mixture. The details of the components are as follows: 13.42 g of PT-110 (trade name, plate-like boron nitride particles, average particle size (light scattering method) 45 μm, manufactured by Momentive Performance Materials Inc.), 1.0 g of jER®828 (trade name, bisphenol A epoxy resin, first epoxy resin, liquid, epoxy equivalent 184 to 194 g/eqiv., softening temperature (ring and ball method) below 25° C., melt viscosity (80° C.) 70 mPa·s, manufactured by Japan Epoxy Resins Co., Ltd.), 2.0 g of EPPN-501HY (trade name, triphenylmethane epoxy resin, second epoxy resin, solid, epoxy equivalent 163 to 175 g/eqiv., softening temperature (ring and ball method) 57 to 63° C., manufactured by NIPPON KAYAKU Co., Ltd), and 3 g (solid content 0.15 g) (5 mass % per total amount of epoxy resins of jER®828 and EPPN-501HY) of a curing agent (a dispersion liquid of 5 mass % Curezol® 2P4 MHZ-PW (trade name, manufactured by Shikoku Chemicals Corporation.) in methyl ethyl ketone).

In the above-described blending, the volume percentage (vol %) of the boron nitride particles relative to the total volume of the solid content excluding the curing agent (that is, solid content of the boron nitride particle and epoxy resin) was 70 vol %.

Then, the obtained mixture was sandwiched by two silicone-treated releasing films, and then these were hot-pressed with a vacuum hot-press at 80° C. under an atmosphere (vacuum atmosphere) of 10 Pa with a load of 5 tons (20 MPa) for 2 minutes. A pressed sheet having a thickness of 0.3 mm was thus obtained (ref: FIG. 2 (a)).

Thereafter, the obtained pressed sheet was cut so as to be divided into a plurality of pieces when projected in the thickness direction of the pressed sheet. Divided sheets were thus obtained (ref: FIG. 2 (b)). Next, the divided sheets were laminated in the thickness direction. A laminated sheet was thus obtained (ref: FIG. 2 (c)).

Then, the obtained laminated sheet was hot-pressed under the same conditions as described above with the above-described vacuum hot-press (ref: FIG. 2 (a)).

Then, a series of the above-described operations of cutting, laminating, and hot-pressing (ref: FIG. 2) was repeated four times. A thermal conductive sheet (B-STAGE) having a thickness of 0.3 mm was thus obtained.

Thereafter, the obtained thermal conductive sheet was introduced into a dryer, and heated at 150° C. for 120 minutes so as to be cured by heat.

### Examples 2 to 9 and 11 to 16

Thermal conductive sheets were obtained in the same manner as in Example 1 in conformity with the mixing formulation and production conditions shown in Table 1 to Table 3.

### Example 10

A mixture was prepared by blending and stirring components (boron nitride particles and polyethylene) in accordance with the mixing formulation of Table 2. That is, during the stirring of the components, the mixture was heated to 130° C., and polyethylene was melted.

Then, the obtained mixture was sandwiched by two silicone-treated releasing films, and then these were hot-pressed with a vacuum hot-press at 120° C. under an atmosphere (vacuum atmosphere) of 10 Pa with a load of 1 ton (4 MPa) for 2 minutes. A pressed sheet having a thickness of 0.3 mm was thus obtained (ref: FIG. 2 (a)).

Thereafter, the obtained pressed sheet was cut so as to be divided into a plurality of pieces when projected in the thickness direction of the pressed sheet. Divided sheets were thus obtained (ref: FIG. 2 (b)). Next, the divided sheets were laminated in the thickness direction. A laminated sheet was thus obtained (ref: FIG. 2 (c)).

Then, the obtained laminated sheet was hot-pressed under the same conditions as described above with the above-described vacuum hot-press (ref: FIG. 2 (a)).

Then, a series of the above-described operations of cutting, laminating, and pressing (ref: FIG. 2) was repeated four times. A thermal conductive sheet having a thickness of 0.3 mm was thus obtained.

The thermal conductive sheets of Examples 1 to 16 before being cured by heat were used as the thermal conductive sheets of Preparation Examples 1 to 16, respectively.

### Production of Thermal Conductive Adhesive Sheet

### Example 17

A varnish (solvent: MEK, solid content concentration: 50 mass %, fillerless type) of epoxy thermosetting adhesive was applied to the surface of a separator so that the thickness thereof when dried was 25 μm. Then, the MEK was distilled away by vacuum drying, thereby forming an adhesive layer.

Then, the adhesive layer of Preparation Example 1 was pressure bonded to the thermal conductive layer, thus producing a thermal conductive adhesive sheet (ref: FIG. 6).

### Examples 18 to 32

Thermal conductive adhesive sheets were made in the same manner as in Example 1 (ref. FIG. 6), except that the thermal conductive layers of Preparation Examples 2 to 16 described in Table 4 were used instead of the thermal conductive layer of Preparation Example 1.

### Example 33

A rubber hot-melt adhesive (trade name: HM409, softening temperature 110° C., melt viscosity (180° C.) 1200 mPa·s, manufactured by CEMEDINE Co., ltd.) was laminated on the thermal conductive layer of Example 17, with a stainless steel-made metal mask (thickness 100 μm, silicone treated for removal on the back face) interposed therebetween. The stainless steel-made metal mask had a pattern that matches the electronic components (IC chip, condenser, coil, and resistor) to be described in detail in the evaluation below. Thereafter, the metal mask was removed, thereby forming an adhesive layer having a thickness of 100 μm and in which an opening is formed.

A thermal conductive adhesive sheet was made in this manner (ref. FIG. 8).

### Examples 34 to 48

Thermal conductive adhesive sheets were made in the same manner as in Example 33 (ref. FIG. 5) except that the thermal conductive layers of Preparation Examples 2 to 16 described in Table 4 were used instead of the thermal conductive layer of Preparation Example 1.

### (Adhesion of Thermal Conductive Adhesive Sheet to Mounting Substrate)

### A. Adhesion of the Thermal Conductive Adhesive Sheets of Examples 17 to 32 to Mounting Substrates

A mounting substrate on which electronic components (IC chip, condenser, coil, and resistor) were mounted was prepared (ref. FIG. 7(a)).

Then, the thermal conductive adhesive sheets of Examples 17 to 32 were temporarily fixed to the electronic components and the mounting substrates by thermocompression bonding using a sponge roll made of silicone resin at 80° C. In the thermocompression bonding, the electronic components penetrated the adhesive layer, and were brought into contact with the thermal conductive layer.

Thereafter, by heating at 150° C. for 120 minutes, both of the thermal conductive layer and the adhesive layer were allowed to be cured by heat, thereby allowing the thermal conductive adhesive sheet to adhere to the electronic components and the mounting substrate (ref. FIG. 4(b)).

In the curing by heat, the thermal conductive layer was allowed to adhere to the surface of the electronic components, and the adhesive layer was allowed to adhere to the surface of the mounting substrate and the side face of the electronic components.

### B. Adhesion of the Thermal Conductive Adhesive Sheets of Examples 33 to 48 to Mounting Substrates

A mounting substrate on which electronic components (IC chip, condenser, coil, and resistor) were mounted was prepared (ref. FIG. 9(a)).

Then, the thermal conductive adhesive sheets of Examples 33 to 48 were positioned relative to the electronic components so that the electronic components and the openings of the adhesive layer are at the same position in the thickness direction. Thereafter, the electronic components were allowed to be fitted to the openings, and the thermal conductive adhesive sheets were thermocompression bonded to the mounting substrate at 120° C.

By this thermocompression bonding, the adhesive layer was melted to be heat-fused to the surface of the mounting substrate and the side face of the electronic components, and the thermal conductive layer was cured by heat and solidified, thereby being adhered to the surface of the electronic components. Thereafter, by being allowed to stand at room temperature to be cooled, the adhesive was solidified, and allowed to adhere to the surface of the mounting substrate and the side face of the electronic components.

The thermal conductive adhesive sheets were allowed to adhere to the mounting substrate in this manner (ref. FIG. 9(b)).

### Evaluation

### 1. Thermal Conductivity

The thermal conductivity of the thermal conductive sheets obtained in Examples 1 to 16 was measured.

That is, the thermal conductivity in the plane direction (SD) was measured by a pulse heating method using a xenon flash analyzer “LFA-447” (manufactured by Erich NETZSCH GmbH & Co. Holding KG).

The results are shown in Tables 1 to 3.

### 2. Volume Resistivity

The volume resistivity (R) of the thermal conductive sheet obtained in Examples 1 to 16 was measured.

That is, the volume resistivity (R) of the thermal conductive sheet was measured in conformity with JIS K 6911 (testing methods for thermosetting plastics, 2006).

The results are shown in Tables 1 to 3.

### 3. Transmittance (JIS K 7361-1 (1997))

The transmittance of light at a wavelength of 500 nm of the thermal conductive sheets having a thickness of 300 μm obtained in Examples 1 to 16 was measured in conformity with JIS K 7361-1 (1997).

That is, the transmittance of the thermal conductive sheets was measured in conformity with the description of JIS K 7361-1 (1997) “Plastics—Determination of the total luminous transmittance of transparent materials” using a spectrophotometer (U-4100, manufactured by Hitachi, Ltd.) equipped with an integrating sphere.

The results are shown in Tables 1 to 3.

### 4. Hiding Characteristics

The thermal conductive sheets having a thickness of 300 μm obtained in Examples 1 to 16 were bonded to the surface of the zebra sheet (trade name, a resin sheet having a yellow and black stripe pattern on the surface thereof, manufactured by Nihon Reflect Chemical Industry inc.).

### 5. Adhesiveness

The thermal conductive adhesive sheets obtained in Examples 17 to 48 were tried to peel off from the mounting substrate. As a result, cohesive failure occurred in any of the thermal conductive adhesive sheets (that is, fracture of adhesive layer).

Thus, it was confirmed that the thermal conductive adhesive sheets of Examples 17 to 48 were excellent in adhesiveness or pressure-sensitive adhesiveness. The results are shown in Table 4 and Table 5.

### 6. Surface Reflectance

The surface reflectance (R) of light at 500 nm of the thermal conductive sheet obtained in Example 1 was measured.

That is, surface reflectance (R) was measured using a spectrophotometer (U4100, manufactured by Hitachi High-Technologies Corporation.) at an incident angle of 5 degrees. The surface reflectance (R) of the thermal conductive sheet was measured using an integrating sphere, setting the reflectance of barium sulfate powder as the basis of the surface reflectance (that is, 100%).

The thermal conductive sheet (in B-stage) was heated at 150° C. for 120 minutes to be cured (completely cured), and then thereafter subjected to the surface reflectance measurement.

The results are shown in Tables 1 to 3.

### 7. Porosity (P)

The porosity (P1) of the thermal conductive sheets before curing by heat in Examples 1 to 16 was measured by the following method.

Measurement method of porosity: The thermal conductive sheet was cut along the thickness direction with a cross section polisher (CP); and the cross section thus appeared was observed with a scanning electron microscope (SEM) at a magnification of 200. The obtained image was binarized based on the pore portion and the non-pore portion; and the area ratio, i.e., the ratio of the pore portion area to the total area of the cross section of the thermal conductive sheet was calculated.

The results are shown in Tables 1 to 3.

### 8. Conformability to Irregularities (3-Point Bending Test)

The 3-point bending test in conformity with JIS K 7171 (2010) was carried out for the thermal conductive sheets before curing by heat of Examples 1 to 16 with the following test conditions, thus evaluating conformability to irregularities with the following evaluation criteria. The results are shown in Tables 1 to 3.

### Test Conditions:

Test Piece: size 20 mm×15 mm

Distance Between Supporting Points: 5 mm

Testing Speed: 20 mm/min (indenter depressing speed)

Bending Angle: 120 degrees

### (Evaluation Criteria)

Excellent: No fracture was observed.

Good: Almost no fracture was observed.

Bad: Fracture was clearly observed.

### 9. Printed Mark Visibility (Mark Adhesion by Printing: Mark Adhesion by Inkjet Printing or Laser Printing)

Marks were printed on the thermal conductive sheets of Examples 1 to 16 by inkjet printing and laser printing, and the marks were observed.

As a result, it was confirmed that the marks were excellently visible in both cases of inkjet printing and laser printing, and that mark adhesion by printing was excellent in any of the thermal conductive sheets of Examples 1 to 16.

TABLE 1

| | | | | Average Particle Size | Example | | | | | |
|---|---|---|---|---|---|---|---|---|---|---|
| | | | | (μm) | Ex. 1 | Ex. 2 | Ex. 3 | Ex. 4 | Ex. 5 | Ex. 6 |
| Mixing | Boron Nitride | PT-110*¹ | | 45 | 13.42 | 3.83 | 5.75 | 12.22 | 23 | — |
| Formulation | Particle/g*^{A}/ | | | | [70] | [40] | [50] | [68] | [80] | |
| of | [vol %]*^{B}/ | | | | [69] | [38.8] | [48.8] | [66.9] | [79.2] | |
| Components | [vol %]*^{C} | UHP-1*² | | 9 | — | — | — | — | — | 12.22 |
| | | | | | | | | | | [68] |
| | | | | | | | | | | [66.9] |
| | Polymer | Thermo- | Epoxy | Epoxy Resin A*³ | — | 3 | 3 | 3 | 3 | 3 |
| | | setting | Resin | (Semi-solid) | | | | | | |
| | | Resin | Compo- | Epoxy Resin B*⁴ | 1 | — | — | — | — | — |
| | | | sition | (Liquid) | | | | | | |
| | | | | Epoxy Resin C*⁵ | — | — | — | — | — | — |
| | | | | (Solid) | | | | | | |
| | | | | Epoxy Resin D*⁶ | 2 | — | — | — | — | — |
| | | | | (Solid) | | | | | | |
| | | | | Curing Agent*⁷ | — | 3 | 3 | 3 | 3 | 3 |
| | | | | (Solid Content | | (0.15) | (0.15) | (0.15) | (0.15) | (0.15) |
| | | | | in Grams) | | | | | | |
| | | | | Curing Agent*⁸ | 3 | — | — | — | — | — |
| | | | | (Solid Content | (0.15) | | | | | |
| | | | | in Grams) | | | | | | |

| | | | | | | | |
|---|---|---|---|---|---|---|---|
| Thermo- | Polyethylene*⁹ | — | — | — | — | — | — |
| plastic | | | | | | | |
| Resin | | | | | | | |

| Production | Hot- | Temperature (° C.) | | 80 | 80 | 80 | 80 | 80 | 80 |
|---|---|---|---|---|---|---|---|---|---|
| Conditions | pressing | Number of Time (Times)*^{D} | | 5 | 5 | 5 | 5 | 5 | 5 |
| | | Load (MPa)/(tons) | | 20/5 | 20/5 | 20/5 | 20/5 | 20/5 | 20/5 |
| Evaluation | Thermal | Thermal | Plane Direction (SD) | 30 | 4.5 | 6.0 | 30.0 | 32.5 | 17.0 |
| | Conductive | Conductivity | Thickness Direction | 2.0 | 1.3 | 3.3 | 5.0 | 5.5 | 5.8 |
| | Sheet | (W/m · K) | (TD) | | | | | | |
| | | | Ratio (SD/TD) | 15.0 | 3.5 | 1.8 | 6.0 | 5.9 | 2.9 |

| | | | | | | | |
|---|---|---|---|---|---|---|---|
| | Volume Resistivity (Ω · cm) | 2 × 10¹⁴ | 5.5 × 10¹⁴ | 3.4 × 10¹⁴ | 2.1 × 10¹⁴ | 1.3 × 10¹⁴ | 1.7 × 10¹⁴ |
| | JIS K 6911 (2006) | | | | | | |
| | Transmittance (%) | 5 | 10 | 9 | 6 | 2 | 7 |
| | JIS K 7361-I (1997) | | | | | | |
| | Hiding Characteristics | Good | Good | Good | Good | Good | Good |
| | Surface Reflectance (%) | 83 | 71 | 72 | 80 | 90 | 73 |
| | (Relative to Surface reflectance of BaSO₄) | | | | | | |
| | Porosity (vol %) | 4 | 0 | 0 | 5 | 12 | 6 |
| | Conformability to Irregularities/ | Excellent | Good | Good | Good | Good | Good |
| | 3-point bending test | | | | | | |
| | JIS K 7171 (2008) | | | | | | |
| Boron Nitride | Orientation Angle (α)(degrees) | 12 | 18 | 18 | 15 | 13 | 20 |
| Particles | | | | | | | |

g*^{A}Blended Weight
[vol %]*^{B}Percentage relative to the total volume of the thermal conductive sheet (excluding curing agent)
[vol %]*^{C}Percentage relative to the total volume of the thermal conductive sheet
Number of Time*^{D}Number of times of hot-pressing of laminated sheet

TABLE 2

| | | | | Average Particle Size | Example | | | | |
|---|---|---|---|---|---|---|---|---|---|
| | | | | (μm) | Ex. 7 | Ex. 8 | Ex. 9 | Ex. 10 | Ex. 11 |
| Mixing | Boron Nitride | PT-110*¹ | | 45 | 12.22 | 12.22 | 12.22 | 3.83 | 13.42 |
| Formulation | Particle/g*^{A}/ | | | | [68] | [68] | [68] | [60] | [70] |
| of | [vol %]*^{B}/ | | | | [66.9] | [66.9] | [66.9] | [60] | [69] |
| Components | [vol %]*^{C} | UHP-1*² | | 9 | — | — | — | — | — |
| | Polymer | Thermosetting | Epoxy Resin | Epoxy Resin A*³ | — | — | — | — | — |
| | | Resin | Composition | (Semi-solid) | | | | | |
| | | | | Epoxy Resin B*⁴ | 1.5 | 3 | — | — | — |
| | | | | (Liquid) | | | | | |
| | | | | Epoxy Resin C*⁵ | 1.5 | — | 3 | — | — |
| | | | | (Solid) | | | | | |
| | | | | Epoxy Resin D*⁶ | — | — | — | — | 3 |
| | | | | (Solid) | | | | | |
| | | | | Curing Agent*⁷ | 3 | 3 | 3 | — | 3 |
| | | | | (Solid Content in Grams) | (0.15) | (0.15) | (0.15) | | (0.15) |
| | | | | Curing Agent*⁸ | — | — | — | — | — |
| | | | | (Solid Content in Grams) | | | | | |

| | | | | | | |
|---|---|---|---|---|---|---|
| Thermoplastic | Polyethylene*⁹ | — | — | — | 1 | — |
| Resin | | | | | | |

| Production | Hot- | Temperature (° C.) | | 80 | 80 | 80 | 120 | 80 |
|---|---|---|---|---|---|---|---|---|
| Conditions | pressing | Number of Time (Times)*^{D} | | 5 | 5 | 5 | 5 | 5 |
| | | Load (MPa)/(tons) | | 20/5 | 20/5 | 20/5 | 4/1 | 20/5 |
| Evaluation | Thermal | Thermal Conductivity | Plane Direction (SD) | 30.0 | 30.0 | 30.0 | 20 | 24.5 |
| | Conductive | (W/m · K) | Thickness Direction | 5.0 | 5.0 | 5.0 | 2.0 | 2.1 |
| | Sheet | | (TD) | | | | | |
| | | | Ratio (SD/TD) | 6.0 | 6.0 | 6.0 | 10.0 | 11.7 |

| | | | | | | |
|---|---|---|---|---|---|---|
| | Volume Resistivity (Ω · cm) | 2.2 × 10¹⁴ | 2.4 × 10¹⁴ | 1.1 × 10¹⁴ | 4.1 × 10¹⁴ | 1.3 × 10¹⁴ |
| | JIS K 6911 (2006) | | | | | |
| | Transmittance (%) | 6 | 6 | 5 | 8 | 5 |
| | JIS K 7361-I (1997) | | | | | |
| | Hiding Characteristics | Good | Good | Good | Good | Good |
| | Surface Reflectance (%) | 83 | 82 | 83 | 76 | 83 |
| | (Relative to surface reflectance of BaSO₄) | | | | | |
| | Porosity (vol %) | 4 | 2 | 13 | 1 | 10 |
| | Conformability to Irregularities/3-point bending test | Good | Good | Bad | Bad | Bad |
| | JIS K 7171 (2008) | | | | | |
| Boron Nitride | Orientation Angle (α)(degrees) | 15 | 16 | 16 | 15 | 16 |
| Particles | | | | | | |

g*^{A}Blended Weight
[vol %]*^{B}Percentage relative to the total volume of the thermal conductive sheet (excluding curing agent)
[vol %]*^{C}Percentage relative to the total volume of the thermal conductive sheet
Number of Time*^{D}Number of times of hot-pressing of laminated sheet

TABLE 3

| | | | | Average Particle Size | Example | | | | |
|---|---|---|---|---|---|---|---|---|---|
| | | | | (μm) | Ex. 12 | Ex. 13 | Ex. 14 | Ex. 15 | Ex. 16 |
| Mixing | Boron Nitride | PT-110*¹ | | 45 | 3.83 | 13.42 | 13.42 | 13.42 | 13.42 |
| Formulation | Particle/g*^{A}/ | | | | [40] | [70] | [70] | [70] | [70] |
| of | [vol %]*^{B}/ | | | | [37.7] | [69] | [69] | [69] | [69] |
| Components | [vol %]*^{C} | UHP-1*² | | 9 | — | — | — | — | — |
| | Polymer | Thermosetting | Epoxy Resin | Epoxy Resin A*³ | 3 | 3 | 3 | 3 | 3 |
| | | Resin | Composition | (Semi-solid) | | | | | |
| | | | | Epoxy Resin B*⁴ | — | — | — | — | — |
| | | | | (Liquid) | | | | | |
| | | | | Epoxy Resin C*⁵ | — | — | — | — | — |
| | | | | (Solid) | | | | | |
| | | | | Epoxy Resin D*⁶ | — | — | — | — | — |
| | | | | (Solid) | | | | | |
| | | | | Curing Agent*⁷ | 6 | 3 | 3 | 3 | 3 |
| | | | | (Solid Content in Grams) | (0.3) | (0.15) | (0.15) | (0.15) | (0.15) |
| | | | | Curing Agent*⁸ | — | — | — | — | — |
| | | | | (Solid Content in Grams) | | | | | |

| | | | | | | |
|---|---|---|---|---|---|---|
| Thermoplastic | Polyethylene*⁹ | — | — | — | — | — |
| Resin | | | | | | |

| Production | Hot- | Temperature (° C.) | | 80 | 60 | 70 | 80 | 80 |
|---|---|---|---|---|---|---|---|---|
| Conditions | pressing | Number of Time (Times)*^{D} | | 5 | 5 | 5 | 5 | 5 |
| | | Load (MPa)/(tons) | | 20/5 | 20/5 | 20/5 | 20/5 | 40/10 |
| Evaluation | Thermal | Thermal Conductivity | Plane Direction (SD) | 4.1 | 10.5 | 11.2 | 32.5 | 50.7 |
| | Conductive | (W/m · K) | Thickness Direction | 1.1 | 2.2 | 3.0 | 5.5 | 7.3 |
| | Sheet | | (TD) | | | | | |
| | | | Ratio (SD/TD) | 3.7 | 4.8 | 3.7 | 5.9 | 6.9 |

| | | | | | | |
|---|---|---|---|---|---|---|
| | Volume Resistivity (Ω · cm) | 6.4 × 10¹⁻ | 0.6 × 10¹⁴ | 0.8 × 10¹⁴ | 2.5 × 10¹⁴ | 5.3 × 10¹⁴ |
| | JIS K 6911 (2006) | | | | | |
| | Transmittance (%) | 9 | 5 | 7 | 5 | 6 |
| | JIS K 7361-I (1997) | | | | | |
| | Hiding Characteristics | Good | Good | Good | Good | Good |
| | Surface Reflectance (%) | 72 | 81 | 81 | 83 | 82 |
| | (Relative to surface reflectance of BaSO₄) | | | | | |
| | Porosity (vol %) | 0 | 29 | 26 | 8 | 3 |
| | Conformability to Irregularities/3-point bending test | Excellent | Excellent | Excellent | Excellent | Good |
| | JIS K 7171 (2008) | | | | | |
| Boron Nitride | Orientation Angle (α)(degrees) | 20 | 17 | 15 | 15 | 13 |
| Particles | | | | | | |

g*^{A}Blended Weight
[vol %]*^{B}Percentage relative to the total volume of the thermal conductive sheet (excluding curing agent)
[vol %]*^{C}Percentage relative to the total volume of the thermal conductive sheet
Number of Time*^{D}Number of times of hot-pressing of laminated sheet

In Tables 1 to 3, values for the components are in grams unless otherwise specified.

In the rows of “boron nitride particles” in Tables 1 to 3, values on the top represent the Blended Weight (g) of the boron nitride particles; values in the middle represent the volume percentage (vol %) of the boron nitride particles relative to the total volume of the solid content excluding the curing agent in the thermal conductive sheet (that is, solid content of the boron nitride particles, and epoxy resin or polyethylene); and values at the bottom represent the volume percentage (vol %) of the boron nitride particles relative to the total volume of the solid content in the thermal conductive sheet (that is, solid content of boron nitride particles, epoxy resin, and curing agent).

For the components with “*” added in Tables 1 to 3, details are given below.

PT-110*¹: trade name, plate-like boron nitride particles, average particle size (light scattering method) 45 manufactured by Momentive Performance Materials Inc.
UHP-1*²: trade name: SHOBN®UHP-1, plate-like boron nitride particles, average particle size (light scattering method) 9 manufactured by Showa Denko K.K.
Epoxy Resin A*³: OGSOL EG (trade name), bisarylfluorene epoxy resin, semi-solid, epoxy equivalent 294 g/eqiv., softening temperature (ring and ball test) 47° C., melt viscosity (80° C.) 1360 mPa·s, manufactured by Osaka Gas Chemicals Co., Ltd.
Epoxy Resin B*⁴: jER® 828 (trade name), bisphenol A epoxy resin, liquid, epoxy equivalent 184 to 194 g/eqiv., softening temperature (ring and ball test) below 25° C., melt viscosity (80° C.) 70 mPa·s, manufactured by Japan Epoxy Resins Co., Ltd.
Epoxy Resin C*⁵: jER® 1002 (trade name), bisphenol A epoxy resin, solid, epoxy equivalent 600 to 700 g/eqiv., softening temperature (ring and ball test) 78° C., melt viscosity (80° C.) 10000 mPa·s or more (measurement limit or more), manufactured by Japan Epoxy Resins Co., Ltd.
Epoxy Resin D*⁶: EPPN-501HY (trade name), triphenylmethane epoxy resin, solid, epoxy equivalent 163 to 175 g/eqiv., softening temperature (ring and ball test) 57 to 63° C., manufactured by NIPPON KAYAKU Co., Ltd.
Curing Agent*⁷: a solution of 5 mass % Curezol® 2PZ (trade name, manufactured by Shikoku Chemicals Corporation) in methyl ethyl ketone.
Curing Agent*⁸: a dispersion of 5 mass % Curezol® 2P4 MHZ-PW (trade name, manufactured by Shikoku Chemicals Corporation) in methyl ethyl ketone.
Polyethylene*⁹: low density polyethylene, weight average molecular weight (Mw) 4000, number average molecular weight (Mn) 1700, manufactured by Sigma-Aldrich Co.

TABLE 4

| | | Thermal Conductive Adhesive Sheet | | | | | | | | |
|---|---|---|---|---|---|---|---|---|---|---|
| | | Ex. 17 | Ex. 18 | Ex. 19 | Ex. 20 | Ex. 20 | Ex. 22 | Ex. 23 | Ex. 24 | Ex. 25 |
| | | Thermal Conductive Layer | | | | | | | | |
| | | Prepa- | Prepa- | Prepa- | Prepa- | Prepa- | Prepa- | Prepa- | Prepa- | Prepa- |
| | | ration | ration | ration | ration | ration | ration | ration | ration | ration |
| Adhesive | | Ex. 1 | Ex. 2 | Ex. 3 | Ex. 4 | Ex. 5 | Ex. 6 | Ex. 7 | Ex. 8 | Ex. 9 |
| Layer | Opening*¹ | Absent | | | | | | | | |
| Evaluation of | Adhesiveness | Cohesive | Cohesive | Cohesive | Cohesive | Cohesive | Cohesive | Cohesive | Cohesive | Cohesive |
| Thermal | (pressure- | Failure | Failure | Failure | Failure | Failure | Failure | Failure | Failure | Failure |
| Conductive | sensitive | | | | | | | | | |
| Adhesive | adhesiveness) | | | | | | | | | |
| Sheet | (To mounting | | | | | | | | | |
| | substrate) | | | | | | | | | |

| | | Thermal Conductive Adhesive Sheet | | | | | | |
|---|---|---|---|---|---|---|---|---|
| | | Ex. 26 | Ex. 27 | Ex. 28 | Ex. 29 | Ex. 30 | Ex. 31 | Ex. 32 |
| | | Thermal Conductive Layer | | | | | | |
| | | Prepa- | Prepa- | Prepa- | Prepa- | Prepa- | Prepa- | Prepa- |
| | | ration | ration | ration | ration | ration | ration | ration |
| Adhesive | | Ex. 10 | Ex. 11 | Ex. 12 | Ex. 13 | Ex. 14 | Ex. 15 | Ex. 16 |
| Layer | Opening*¹ | Absent | | | | | | |
| Evaluation of | Adhesiveness | Cohesive | Cohesive | Cohesive | Cohesive | Cohesive | Cohesive | Cohesive |
| Thermal | (pressure- | Failure | Failure | Failure | Failure | Failure | Failure | Failure |
| Conductive | sensitive | | | | | | | |
| Adhesive | adhesiveness) | | | | | | | |
| Sheet | (To mounting | | | | | | | |
| | substrate) | | | | | | | |

*¹Opening: pattern that matches electronic components

TABLE 5

| | | Thermal Conductive Adhesive Sheet | | | | | | | | |
|---|---|---|---|---|---|---|---|---|---|---|
| | | Ex. 33 | Ex. 34 | Ex. 35 | Ex. 36 | Ex. 37 | Ex. 38 | Ex. 39 | Ex. 40 | Ex. 41 |
| | | Thermal Conductive Layer | | | | | | | | |
| | | Prepa- | Prepa- | Prepa- | Prepa- | Prepa- | Prepa- | Prepa- | Prepa- | Prepa- |
| | | ration | ration | ration | ration | ration | ration | ration | ration | ration |
| Adhesive | | Ex. 1 | Ex. 2 | Ex. 3 | Ex. 4 | Ex. 5 | Ex. 6 | Ex. 7 | Ex. 8 | Ex. 9 |
| Layer | Opening*¹ | Present | | | | | | | | |
| Evaluation of | Adhesiveness | Cohesive | Cohesive | Cohesive | Cohesive | Cohesive | Cohesive | Cohesive | Cohesive | Cohesive |
| Thermal | (pressure- | Failure | Failure | Failure | Failure | Failure | Failure | Failure | Failure | Failure |
| Conductive | sensitive | | | | | | | | | |
| Adhesive | adhesiveness) | | | | | | | | | |
| Sheet | (To mounting | | | | | | | | | |
| | substrate) | | | | | | | | | |

| | | Thermal Conductive Adhesive Sheet | | | | | | |
|---|---|---|---|---|---|---|---|---|
| | | Ex. 42 | Ex. 43 | Ex. 44 | Ex. 45 | Ex. 46 | Ex. 47 | Ex. 48 |
| | | Thermal Conductive Layer | | | | | | |
| | | Prepa- | Prepa- | Prepa- | Prepa- | Prepa- | Prepa- | Prepa- |
| | | ration | ration | ration | ration | ration | ration | ration |
| Adhesive | | Ex. 10 | Ex. 11 | Ex. 12 | Ex. 13 | Ex. 14 | Ex. 15 | Ex. 16 |
| Layer | Opening*¹ | Present | | | | | | |
| Evaluation of | Adhesiveness | Cohesive | Cohesive | Cohesive | Cohesive | Cohesive | Cohesive | Cohesive |
| Thermal | (pressure- | Failure | Failure | Failure | Failure | Failure | Failure | Failure |
| Conductive | sensitive | | | | | | | |
| Adhesive | adhesiveness) | | | | | | | |
| Sheet | (To mounting | | | | | | | |
| | substrate) | | | | | | | |

*¹Opening: pattern that matches electronic components

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A thermal conductive sheet comprising a plate-like boron nitride particle, wherein
the thermal conductivity in a direction perpendicular to the thickness direction of the thermal conductive sheet is 4 W/m·K or more, and
the volume resistivity is 1×10¹⁰ Ω·cm or more.

2. A thermal conductive sheet comprising a plate-like boron nitride particle, wherein
the thermal conductivity in a direction perpendicular to the thickness direction of the thermal conductive sheet is 4 W/m·K or more, and
the thermal conductive sheet having a thickness of 300 μm has a transmittance of light at a wavelength of 500 nm of 10% or less.

3. A thermal conductive sheet comprising a plate-like boron nitride particle, wherein
the thermal conductivity in a direction perpendicular to the thickness direction of the thermal conductive sheet is 4 W/m·K or more, and
the surface reflectance of light at 500 nm is 70% or more relative to the surface reflectance of light at 500 nm of barium sulfate as 100%.

4. A light-emitting diode mounting substrate comprising:
a substrate for mounting a light-emitting diode; and
a thermal conductive light reflection layer,
the thermal conductive light reflection layer being formed on the surface of the substrate, and
the thermal conductive light reflection layer comprising the thermal conductive sheet according to claim 3.

5. A thermal conductive adhesive sheet comprising:
a thermal conductive layer comprising a plate-like boron nitride particle, and having a thermal conductivity in a direction perpendicular to the thickness direction of the thermal conductive layer of 4 W/m·K or more; and
an adhesive layer or a pressure-sensitive adhesive layer laminated on at least one side of the thermal conductive layer.
